(19) United States
(12) Patent Application Publication
(10) Pub. No.: US 2015/0206316 A1
(43) Pub. Date: Jul. 23, 2015

(54) IMAGE-PROCESSING APPARATUS AND IMAGE-PROCESSING METHOD

(71) Applicant: CANON KABUSHIKI KAISHA, Tokyo (JP)

(72) Inventors: Yuka Fujinaka, Ebina-shi (JP); Eito Sakakima, Kamakura-shi (JP); Tatsuya Kimoto, Atsugi-shi (JP)

(21) Appl. No.: 14/601,029

(22) Filed: Jan. 20, 2015

(30) Foreign Application Priority Data
Jan. 23, 2014 (JP) 2014-010316

(51) Int. Cl. G06T 7/00

(52) U.S. Cl. CPC G06T 7/0081; G06T 2207/20112; G06T 2207/30004

(57) ABSTRACT

An image-processing apparatus according to the present invention includes an input unit configured to input an image; and an area-determination unit configured to determine a monochrome area and a color area by performing a first determination process on the input image, wherein the area-determination unit determines a monochrome area and a color area by performing a second determination process, whose processing accuracy is higher than that of the first determination process, on the input image in a case where magnitude of temporal change of a result of the first determination process is a first threshold value or greater.

### BACKGROUND OF THE INVENTION

1. Field of the Invention

The present invention relates to an image-processing apparatus and an image-processing method.

2. Description of the Related Art

In medical sites, for the purpose of confirming an early diagnosis, an accurate diagnosis, the presence of lesion metastasis, or the like, a single or a plurality of segments are photographed by a plurality of photographing methods which are different from each other. The photographing is performed by using a medical imaging apparatus (or modality), for example, a mammography apparatus, ultrasonic diagnostic apparatus, a computed tomography apparatus, a nuclear magnetic resonance imaging apparatus, or the like. A doctor occasionally uses a plurality of medical images photographed by a plurality of modalities in a single diagnosis.

Recently, the resolution of images capable of being displayed by a display apparatus is improved, and a plurality of images are occasionally displayed side-by-side. For example, a plurality of medical images are displayed side-by-side for a diagnosis. The medical images include a monochrome image and a color image. Therefore, the plurality of medical images including the monochrome image and the color image are often arranged to be displayed. Of course, not only the medical image, but also a plurality of images including a monochrome image and a color image are sometimes arranged to be displayed. Required Image quality differs between the monochrome image and the color image. For example, a medical image which is a monochrome image is preferably displayed in accordance with a gamma curve (hereinafter, referred to as a “DICOM gamma curve”) standardized in the Digital Imaging and COmmunication in Medicine (DICOM) standards. On the other hand, a medical image which is a color image is preferably displayed in accordance with a gamma curve exhibiting a gamma value of 2.2 (hereinafter, referred to as a “2.2 gamma curve”). In a case where the monochrome image that is the medical image, to which an image process (gamma correction) using a gamma curve different from the DICOM gamma curve is performed, is displayed, a doctor has to perform a diagnosis by using the image of inadequate image quality, and this may lead to a wrong diagnosis. Also in a case where the color image that is the medical image, to which an image process using a gamma curve different from the 2.2 gamma curve is performed, is displayed, a doctor similarly performs a diagnosis by using the image whose image quality is not preferable, there is a possibility of causing a wrong diagnosis. When an improper image process is performed to not only a medical image but also a monochrome image or a color image, a user sometimes cannot properly determine the image.

Therefore, there is proposed a technology for dividing the area of an image into a monochrome area (area where a monochrome image is displayed) and a color area (area where a color image is displayed) to separately perform an image process on the monochrome area and the color area. Additionally, in order to reduce a burden to a user, there is proposed a technology for automatically performing a dividing process of dividing the area of an image into a monochrome area and a color area.

A conventional technology related to the dividing process is disclosed in, for example, Japanese Patent Application Laid-open No. 2013-89074. Japanese Patent Application Laid-open No. 2013-89074 discloses a technology for highlighting the result of an automatic dividing process (division result) according to user operation such as key operation, and changing an image process to be applied to an area shown in the division result according to user operation. By use of such a technology, it is possible to provide an apparatus that can be used easier by a user. More specifically, the user can confirm whether or not the area of a color image is wrongly determined as a monochrome area, and can confirm whether or not the area of a monochrome image is wrongly determined as a color area. Hence, if the requirement arises, the user can modify an image process to be applied to a wrongly determined area to implement an adequate image process on this area.

### SUMMARY OF THE INVENTION

However, the user operation is burdensome, and therefore the burden on the user is increased by using the technology disclosed in Japanese Patent Application Laid-open No. 2013-89074. Particularly, in a case where the accuracy of the automatic dividing process is low, the user needs to frequently confirm the division result, and therefore a large burden is given to the user.

When a highly precise dividing process is performed, a division result having high reliability can be obtained. Therefore, the user need to confirm the division result fewer times and the burden on the user can be reduce. However, the highly precise dividing process generally has a large processing load. Therefore, the dividing process requires a long processing time, or an expensive arithmetic unit for shortening the processing time of the dividing process is required.

The present invention provides a technology capable of dividing the area of an image into a monochrome area and a color area with a small processing load and high accuracy, and reducing the burden on a user.

The present invention in its first aspect provides an image-processing apparatus comprising:

an input unit configured to input an image; and

an area-determination unit configured to determine a monochrome area and a color area by performing a first determination process on the input image, wherein

the area-determination unit determines a monochrome area and a color area by performing a second determination process, whose processing accuracy is higher than that of the first determination process, on the input image in a case where magnitude of temporal change of a result of the first determination process is a first threshold value or greater.

The present invention in its second aspect provides an image-processing method comprising:

inputting an image; and

determining a monochrome area and a color area by performing a first determination process on the input image, wherein

a monochrome area and a color area are determined by performing a second determination process whose processing accuracy is higher than that of the first determination process on the input image, in a case where magnitude of temporal change of a result of the first determination process is a first threshold value or greater.

The present invention in its third aspect provides a non-transitory computer readable medium that stores a program, wherein the program causes a computer to execute the method.

According to the present invention, the area of an image can be highly precisely divided into a monochrome area and a color area with a small processing load, and the burden on a user can be reduced.

Further features of the present invention will become apparent from the following description of exemplary embodiments with reference to the attached drawings.

### BRIEF DESCRIPTION OF THE DRAWINGS

FIG. 1 is a block diagram showing an example of a configuration of a display apparatus according to a first embodiment;

FIG. 2 is a function block diagram showing an example of the configuration of the display apparatus according to the first embodiment;

FIG. 3 is a flowchart showing an example of a processing flow of a processing-control unit according to the first embodiment;

FIG. 4 is a flowchart showing an example of a processing flow of a differential determination unit according to the first embodiment;

FIGS. 5A and 5B are figures showing an example of a current image and the result of a first dividing process according to the first embodiment;

FIG. 6 is a figure showing an example of division result information according to the first embodiment;

FIGS. 7A and 7B are figures showing an example of a current image and the result of a first dividing process according to the first embodiment;

FIG. 8 is a figure showing an example of division result information according to the first embodiment;

FIGS. 9A and 9B are figures showing an example of a dividing process according to the first embodiment;

FIG. 10 is a figure showing an example of a division result obtained after an update according to the first embodiment;

FIGS. 11A and 11B are figures showing an example of a current image and the result of a first dividing process according to a second embodiment;

FIG. 12 is a figure showing an example of division result information according to the second embodiment;

FIG. 13 is a flowchart showing an example of a processing flow of a differential determination unit according to the second embodiment;

FIGS. 14A and 14B are figures showing an example of a current image and the result of a first dividing process according to a third embodiment;

FIG. 15 is a flowchart showing an example of a processing flow of a differential determination unit according to the third embodiment;

FIG. 16 is a function block diagram showing an example of a configuration of a display apparatus according to a fourth embodiment;

FIG. 17 is a flowchart showing an example of a processing flow of a notification unit according to the fourth embodiment;

FIG. 18 is a figure showing an example of a division result obtained after an update according to the fourth embodiment;

FIG. 19 is a figure showing an example of a division result obtained after an update according to the fourth embodiment;

FIG. 20 is a figure showing an example of a message image according to the fourth embodiment;

FIG. 21 is a flowchart showing an example of a processing flow of a notification unit according to a fifth embodiment; and

FIGS. 22A and 22B are figures showing an example of a current image and a division result obtained after an update according to the fifth embodiment.

### DESCRIPTION OF THE EMBODIMENTS

### First Embodiment

Hereinafter, an image-processing apparatus and an image-processing method according to a first embodiment of the present invention will be described.

The following description covers a display apparatus which divides an input image area into a monochrome area and a color area, and individually applies an image process on the monochrome area and the color area of the input image, and displays an image obtained after the image process. However, the image-processing apparatus according to this embodiment is not limited to this. For example, the image-processing apparatus according to this embodiment may be an apparatus separate from the display apparatus. Additionally, the image process that is individually applied to the monochrome area and the color area of the input image may be performed by an apparatus separate from the image-processing apparatus according to this embodiment. For example, the image-processing apparatus according to this embodiment may be an apparatus that divides the area of an input image into a monochrome area and a color area, and outputs a division result to the outside.

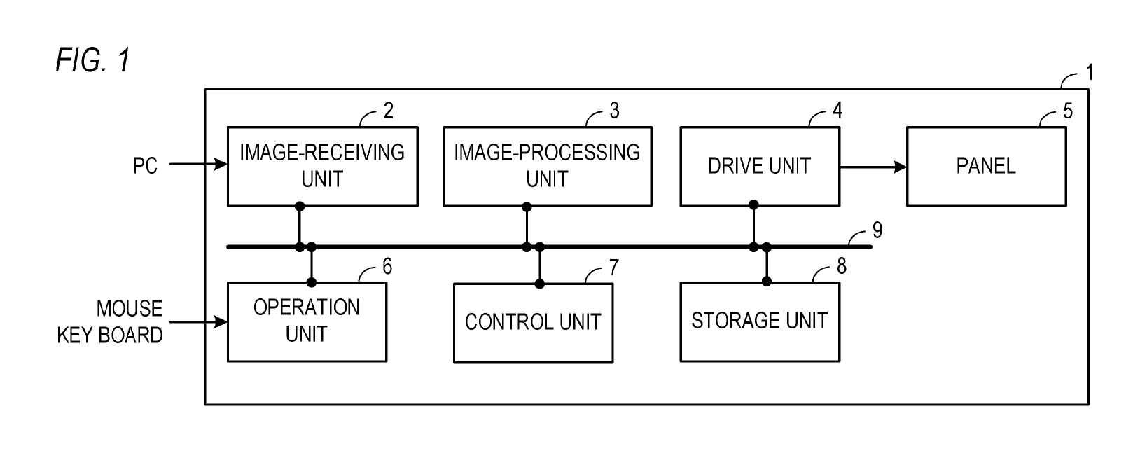

FIG. 1 is a block diagram showing an example of a configuration of a display apparatus 1 according to this embodiment. The display apparatus 1 has an image-receiving unit 2, an image-processing unit 3, a drive unit 4, a panel 5, an operation unit 6, a control unit 7, a storage unit 8, a bus 9, and the like. Function units that are provided in the display apparatus 1 are connected to each other through the bus 9 in a mutually communicable manner.

The display apparatus according to this embodiment performs a process for each frame.

The image-receiving unit 2 receives a current image (current image data) that is output from an external apparatus such as a PC. The current image is an image of a current frame. The image-receiving unit 2 acquires the current image from the external apparatus through an image communication cable such as a Digital Visual Interface (DVI) cable and a DisplayPort cable. The image-receiving unit 2 outputs the received current image to the image-processing unit 3 and the control unit 7.

In this embodiment, a case where image data is RGB image data is described. However, the image data is not limited to the RGB image data. For example, the image data may be YCbCr image data. The RGB image data is image data whose pixel value is the combination of an R value, a G value, and a B value, and the YCbCr image data is image data whose pixel value is the combination of a Y value, a Cb value, and a Cr value.

The current image may not be output to the control unit 7.

The image-processing unit 3 is an integrated circuit that performs an image process using the current image.

In this embodiment, the image-processing unit 3 performs the dividing process by using the current image. The dividing process is a process of dividing the area of an image into a monochrome area and a color area. The monochrome area is an area to which a monochrome attribute is assigned, and the color area is an area to which a color attribute is assigned. The dividing process is performed by using the current image, so that the area of the current image is divided into the monochrome area and the color area.

Then, the image-processing unit 3 individually applies the image process on the monochrome area and the color area of the current image. Hereinafter, the image process that is individually applied to the monochrome area and the color area is referred to as an individual image process. In this embodiment, gamma correction is individually applied to the monochrome area and the color area.

Thereafter, the image-processing unit 3 outputs an image (image data) obtained after the gamma correction to the drive unit 4.

The image-processing unit 3 may apply an image process other than the individual image process on the current image. Examples of the image process other than the individual image process includes, for example, an edge-emphasis process, a blurring process, a frame-rate conversion process, a scaling process, an interpolation-pixel generation process, and the like.

The individual image process is not limited to the gamma correction. For example, the individual image process may be a brightness adjustment process for the monochrome area and a brightness adjustment process for the color area. The individual image process may be a color-temperature adjustment process for the monochrome area and a color-temperature adjustment process for the color area.

The drive unit 4 is a drive circuit that drives the panel 5 according to the image (image data) that is output from the image-processing unit 3.

The panel 5 is a display panel that is driven by the drive unit 4 to display the image output from the image-processing unit 3. In this embodiment, the panel 5 is a liquid crystal panel that has a plurality of liquid crystal devices. Then, the drive unit 4 drives each of the liquid crystal devices, so that the transmittance of each liquid crystal device is controlled and the image is displayed. Additionally, in this embodiment, the panel has resolution of 4096 [pixels] in the horizontal direction×2560 [pixels] in the vertical direction.

The panel 5 is not limited to a liquid crystal panel. For example, the panel 5 may be a plasma display panel, an organic EL display panel, and the like.

The resolution of the panel 5 may be higher or lower than 4096 [pixels] in the horizontal direction×2560 [pixels] in the vertical direction.

The operation unit 6 receives operation information generated according to user operation, and outputs the operation information to the control unit 7. More specifically, the operation unit 6 receives the operation information that shows user operation to an input apparatus, from the input apparatus. The input apparatus is, for example, operation buttons that are provided in the display apparatus 1, a mouse or a key board that is connected to the display apparatus 1, and the like.

The control unit 7 is a central processing unit (CPU) that controls each of the function units that are provided in the display apparatus 1.

In this embodiment, the control unit 7 outputs a first division request showing the execution of a first dividing process that is a dividing process using a first division parameter value, to the image-processing unit 3.

Additionally, the control unit 7 determines a differential value indicating a difference between a division result of a past image and a result of the first dividing process using the current image, on the basis of the division result of the past image and the result of the first dividing process using the current image. The past image is an image of a frame prior to the current frame. In this embodiment, the past image is an image of an immediately preceding frame of the current frame.

In a case where the differential value is a first threshold value or greater, the control unit 7 outputs a second division request showing the execution of a second dividing process that is a dividing process using a second division parameter value, to the image-processing unit 3. The second dividing process is a dividing process whose processing accuracy is higher than that of the first dividing process.

Herein, the “division result of the past image” is a final division result of the past image. In this embodiment, in a case where the second dividing process is performed, a division result reflecting a result of the second dividing process is acquired as the final division result. In a case where the second dividing process is not performed, the result of the first dividing process is acquired as the final division result.

The first threshold value may be a fixed value that is preset by a manufacturer or the like, or may be a value that is changeable by a user.

The storage unit 8 is a storage apparatus that is capable of storing various kinds of information. For example, the storage unit 8 has a nonvolatile memory or a RAM. A program that is executed by the display apparatus 1 is previously stored in the nonvolatile memory. When the program stored in the nonvolatile memory is executed, the program is decompressed in the RAM. In this embodiment, the storage unit 8 previously stores a plurality of division parameter values that include at least the first division parameter value and the second division parameter value. Additionally, during the operation of the display apparatus 1, the division result, the differential value, and the like are stored in the storage unit 8. Information stored in the storage unit 8 is referenced by the image-processing unit 3, the control unit 7, and the like.

The bus 9 is a communication circuit common to the respective function unit that are provided in the display apparatus 1.

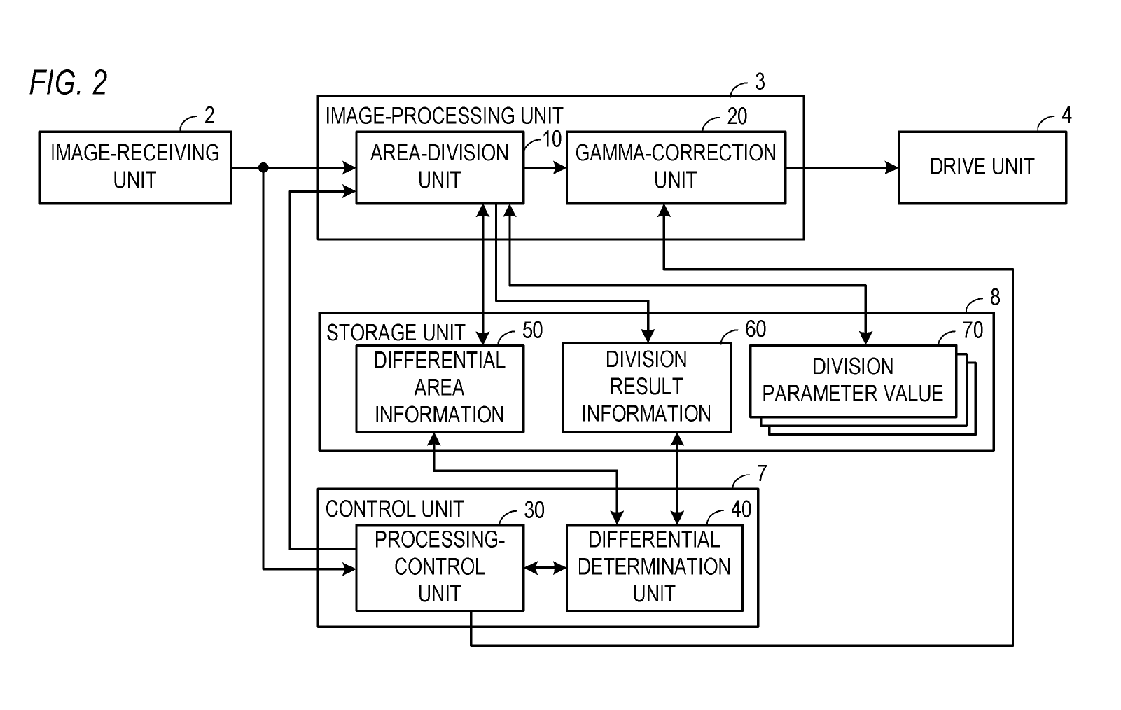

Functions of the image-processing unit 3 and the control unit 7 will be described in detail with reference to a function block diagram shown in FIG. 2.

As shown in FIG. 2, the image-processing unit 3 has an area-division unit 10 and a gamma-correction unit 20.

The area-division unit 10 acquires a current image from the image-receiving unit 2, and acquires a division request from the control unit 7. The area-division unit 10 performs a dividing process according to the division request from the control unit 7. In this embodiment, a division parameter value according to an acquisition request from among a plurality of division parameter values 70 that are stored in the storage unit 8, and a dividing process using the acquired division parameter value is performed. More specifically, in a case where a first division request is output from the control unit 7, a first division parameter value is acquired, and a first dividing process using the current image is performed. Additionally, in a case where a second division request is output from the control unit 7, a second division parameter value is acquired, and a second dividing process using the current image is performed. When the dividing process is completed, the area-division unit 10 outputs a division completion notification showing that the dividing process is completed, to the processing-control unit 30, and outputs division result information showing the division result of the current image, and the current image, to the gamma-correction unit 20. Additionally, when the dividing process is completed, the area-division unit 10 stores division result information 60 showing the division result of the current image, in the storage unit 8.

The gamma-correction unit 20 acquires a correction request (request showing the execution of the gamma correction) from the control unit 7. The gamma-correction unit 20 applies the gamma correction to the current image according to the correction request from the control unit 7. The gamma-correction unit 20 applies the gamma correction to the current image in accordance with the division result information output from the area-division unit 10. In this embodiment, gamma correction using a gamma curve standardized in the Digital Imaging and Communication in Medicine (DICOM) standards (hereinafter, referred to as “DICOM gamma correction”) is applied to the monochrome area. Then, gamma correction using a gamma curve whose gamma value is 2.2 (hereinafter, referred to as “2.2 gamma correction”) is applied to the color area. The gamma-correction unit 20 outputs an image obtained after the gamma correction is output to the drive unit 4.

As shown in FIG. 2, the control unit 7 has a processing-control unit 30 and a differential determination unit 40.

The differential determination unit 40 acquires a differential determination request (request showing the execution of a process of determining a differential value) from the processing-control unit 30. The differential determination unit 40 determines a differential value according to the differential determination request from the processing-control unit 30. More specifically, the differential determination unit 40 holds division result information 60 that is stored in the storage unit 8 at the time of the execution of the process using the past image, as past result information showing the division result of the past image. The differential determination unit 40 acquires division result information 60 showing the result of the first dividing process using the current image, as current result information, from the storage unit 8. Then, the differential determination unit 40 determines a differential value by using the past result information and the current result information.

In a case where the differential value is the first threshold value or greater, the differential determination unit 40 outputs a re-division request showing the output of the second division request, to the processing-control unit 30, and stores differential area information 50 showing a differential area, in the storage unit 8. The differential area is an area that includes an area where an attribute shown by the result of the first dividing process using the current image is different from an attribute shown by the division result of the past image. In this embodiment, the differential area is an area where the attribute shown by the result of the first dividing process using the current image is different from the attribute shown by the division result of the past image.

The differential area may be an area that is larger than the area where the attribute shown by the result of the first dividing process using the current image is different from the attribute shown by the division result of the past image.

The processing-control unit 30 acquires the current image from the image-receiving unit 2, and acquires the re-division request from the differential determination unit 40. The processing-control unit 30 outputs the first division request to the area-division unit 10, and outputs the differential determination request to the differential determination unit 40. Then, the processing-control unit 30 outputs the second division request to the area-division unit 10, according to the re-division request from the differential determination unit 40.

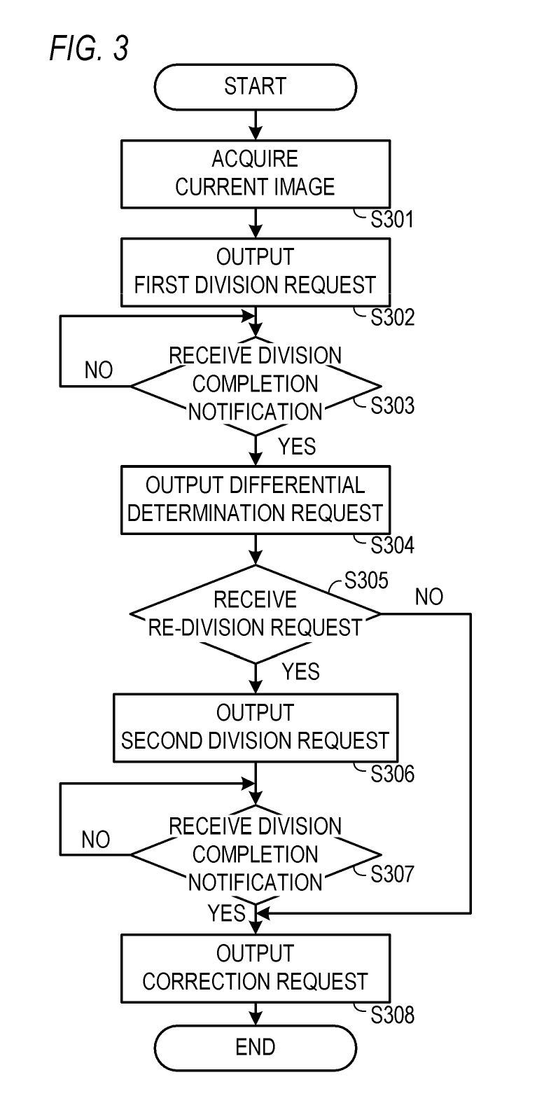

An example of a processing flow of the processing-control unit 30 will be described with reference to a flowchart shown in FIG. 3. Processes shown in FIG. 3 are performed for each frame. That is, the processes shown in FIG. 3 are repeatedly performed in units of a frame.

First, the processing-control unit 30 acquires a current image from the image-receiving unit 2 (S301).

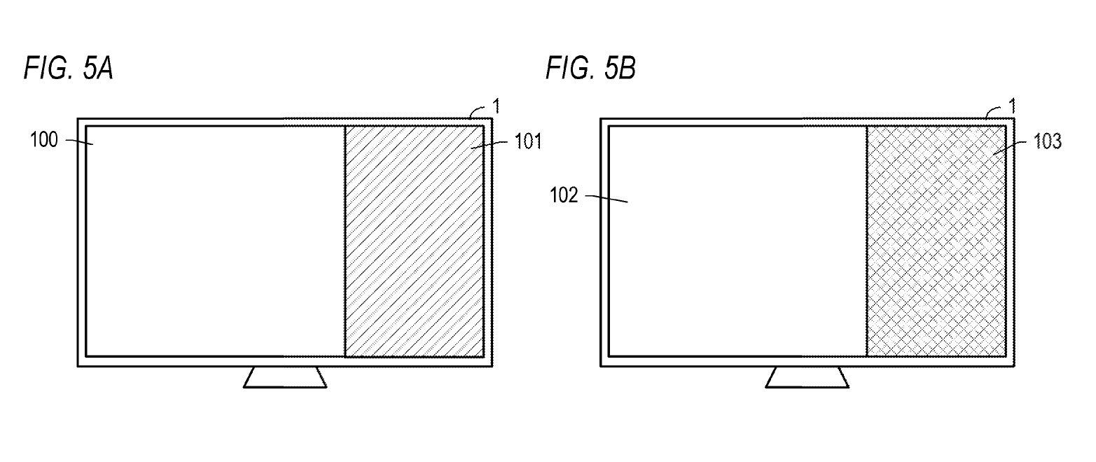

Herein, it is assumed that an image shown in FIG. 5A is acquired as the current image. The current image shown in FIG. 5A is an image in which a monochrome image and a color image are arranged. More specifically, in the current image shown in FIG. 5A, a monochrome image 100 is disposed on the left side, and a color image 101 is disposed on the right side. The monochrome image 100 is a mammography image, and the color image 101 is an elastography image obtained by colorizing an ultrasonic image.

Although FIG. 5A shows an example of a case where the monochrome image and the color image are medical images, the monochrome image and the color image are not limited to medical images. For example, the monochrome image and the color image may be images obtained by photographing a scene, illustrations, text images, or the like.

Then, the processing-control unit 30 outputs a first division request to the area-division unit 10 (S302). The area-division unit 10 performs a first dividing process using the current image, according to the first division request from the processing-control unit 30.

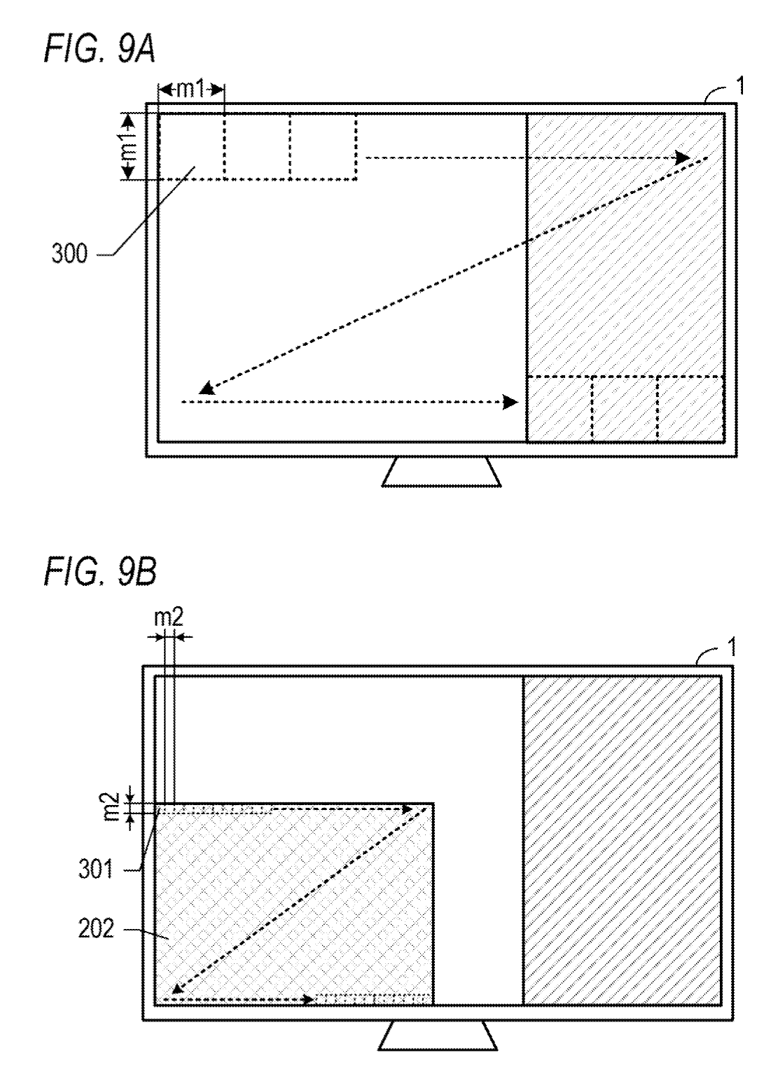

The first dividing process will be described with reference to FIG. 9A.

In this embodiment, a dividing process using a technology disclosed in Japanese Patent Application Laid-open No. 2003-244469 is performed. Additionally, in this embodiment, a process of dividing the area of an image into a monochrome area and a color area in units of an area of first size is performed as the first dividing process.

First, the area-division unit 10 divides the whole area of the current image into a plurality of first small areas 300, as show in FIG. 9A. More specifically, a first division parameter value is acquired from among the plurality of division parameter values 70, according to the first division request. In this embodiment, the first division parameter value shows “m1” which is the size of each of the first small areas 300 (first size). Then, the first small areas which are m1 [pixels]×m1 [pixels] squares are set. In this embodiment, it is assumed that the value of “m1” is 100 [pixels].

The area-division unit 10 converts the pixel value of the current image from the value of an RGB color space (RGB value) into the value of a uniform perception color space. The value of the uniform perception color space is configured from a lightness value according to brightness and perception chromaticity value standardized according to the chroma of a human. For example, the uniform perception color space is an L*a*b* color space of the CIE1976 standards, the lightness value is an L* value, and the perception chromaticity value is the combination of an a* value and a b* value.

The area-division unit 10 determines whether the first small area is the monochrome area or the color area for each first small area, on the basis of an accumulated value of the perception chromaticity values of the pixel of the first small area. For example, it is determined whether or not the first small area is the monochrome area or the color area, on the basis of an accumulated value of the a* values and an accumulated value of the b* values.

Through the above processes, the whole area of the current image is divided into a monochrome area (area configured by one or more first small areas determined as a monochrome area) and a color area (area configured by one or more first small areas determined as a color area).

When the first dividing process is completed, the area-division unit 10 outputs a division completion notification showing that the first dividing process is completed, to the processing-control unit 30, and outputs division result information showing the result of the first dividing process using the current image, and the current image, to the gamma-correction unit 20. Additionally, the area-division unit 10 records division result information 60 showing a first division result using the current image, in the storage unit 8.

The value of “m1” may be larger or smaller than 100 [pixels].

The shapes of the first small areas are not limited to squares. For example, the shapes of the first small areas may be rectangles.

A method of the first dividing process is not limited to the above method. For example, a pixel which satisfies R value=G value=B value may be determined as a monochrome pixel, and it may be determined whether the first small area is the monochrome area or the color area, on the basis of the total number of the monochrome pixels of the first small areas. More specifically, a first small area whose monochrome ratio is a threshold value or greater may be determined as a monochrome area, and a first small area whose monochrome ratio is less than the threshold value may be determined as a color area, the monochrome ratio being a ratio of the total number of the monochrome pixels of the first small area to the total number of pixels of the first small area. In place of the monochrome ratio, a color ratio that is a ratio of the total number of the color pixels of the first small area to the total number of the pixels of the first small area may be employed.

In a case where at least one of the horizontal size and the vertical size of the current image is not an integral multiple of the value of “m1”, the value of “m1” is simply adjusted such that the horizontal size and the vertical size of the current image become the integral multiple of the value of “m1”. Additionally, the size of a part of the first small areas (e.g., first small areas corresponding to edge parts of a screen) may be changed such that the size of the area configured from the plurality of first small areas coincides with the size of the current image.

FIG. 5B shows an example of the result of the first dividing process using the image shown in FIG. 5A. In the example of FIG. 5B, the area of the image shown in FIG. 5A is divided into a monochrome area 102 and a color area 103. The monochrome area 102 is the area of the monochrome image 100, and the color area 103 is the area of the color image 101. The area-division unit 10 records division result information 60 showing the monochrome area 102 and the color area 103 in the storage unit 8. More specifically, the division result information 60 showing the monochrome area 102 and the color area 103 is recorded in the storage unit 8 as the division result of the current image.

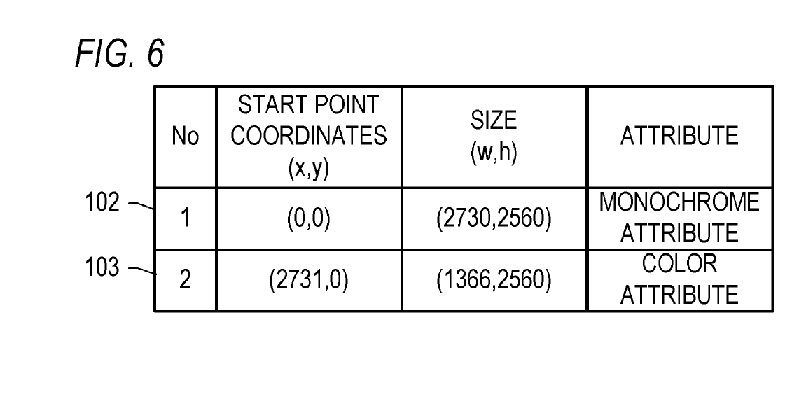

FIG. 6 shows an example of division result information 60 showing the monochrome area 102 and the color area 103. In the example of FIG. 6, numbers (No.), start point coordinates (horizontal position x, vertical position y) of the division areas, the size (horizontal size (width) w, vertical size (height) h) of the division areas, and attributes of the division areas are shown for each division area that is the monochrome area or the color area. More specifically, as to the monochrome area 102, No.=1, start point coordinates (x, y)=(0, 0), size (w, h)=(2730, 2560), and attribute=monochrome attribute are shown. As to the color area 103, No.=2, start point coordinates (x, y)=(2731, 0), size (w, h)=(1366, 2560), and attribute=color attribute are shown.

The division result information 60 is not limited to the information shown in FIG. 6. For example, the division result information 60 may include the center coordinates in place of the start point coordinates. Additionally, the division result information 60 may include the start point coordinates and the end point coordinates in place of the start point coordinates and the size. The division result information 60 may include the start point coordinates and the end point coordinates of each side of the division area in place of the start point coordinates and the size.

Description will return to the description of FIG. 3.

Next to S302, the processing-control unit 30 determines whether or not the division completion notification is output from the area-division unit 10 (S303). In a case where the division completion notification is not output from the area-division unit 10 (S303: no), the processing-control unit 30 waits for the output of the division completion notification from the area-division unit 10. In a case where the division completion notification is output from the area-division unit 10 (S303: yes), the processing-control unit 30 outputs a differential determination request to the differential determination unit 40 (S304).

The differential determination unit 40 determines a differential value according to the differential determination request from the processing-control unit 30. Then, in a case where the determined differential value is the first threshold value or greater, the differential determination unit 40 outputs a re-division request to the processing-control unit 30, and records the differential area information 50 in the storage unit 8.

The details of a method of determining the differential value will be described later.

Next to S304, the processing-control unit 30 determines whether nor not the re-division request is output from the differential determination unit 40 (S305). In a case where the re-division request is not output from the differential determination unit 40 (S305: no), the process advances to S308. In a case where the re-division request is output from the differential determination unit (S305: yes), the process advances to S306.

Herein, it is assumed that the differential value is less than the first threshold value. Therefore, the process advances to S308.

In S308, the processing-control unit 30 outputs a correction request to the gamma-correction unit 20. The gamma-correction unit 20 applies gamma correction to the current image according to the correction request from the control unit 7. The gamma-correction unit 20 applies gamma correction to the current image in accordance with the division result information output from the area-division unit 10. Herein, the gamma correction is individually applied to the monochrome area 102 and the color area 103 shown in FIG. 5B, on the basis of the result of the first dividing process. Then, the gamma-correction unit 20 outputs an image obtained after the gamma correction, to the drive unit 4, and the drive unit 4 drives the panel 5 according to the image obtained after the gamma correction. Consequently, the image obtained after the gamma correction is displayed. At this time, the differential determination unit 40 reads division result information 60 showing the result of the first dividing process using the current image, from the storage unit 8, and holds the read information as the division result of the past image.

Now, a processing flow of the processing-control unit 30 in a case where an image that is considerably different from a past image is acquired as a current image will be described. For example, in a case where an external apparatus that outputs an image to the display apparatus 1 is switched, the image that is considerably different from a past image is sometimes acquired. Additionally, in a case where a monochrome image or a color image arranged in an image is changed, or in a case where the position of a monochrome image or a color image arranged in an image is changed, the image that is considerably different from a past image is sometimes acquired.

First, the processing-control unit 30 acquires a current image from the image-receiving unit 2 (S301).

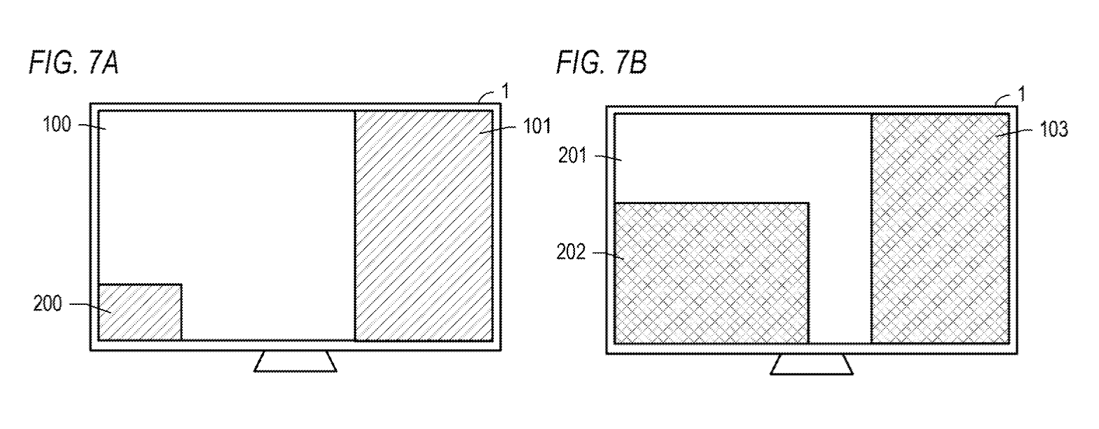

Herein, it is assumed that the past image is the image shown in FIG. 5A, and an image shown in FIG. 7A is acquired as a current image. The current image shown in FIG. 7A is an image obtained by superimposing a color image 200 on the image shown in FIG. 5A. The color image 200 is, for example, a CT image, and an image of a window that is different from the monochrome image 100 and the color image 101.

The processing-control unit 30 outputs a first division request to the area-division unit 10 (S302). The area-division unit 10 performs a first dividing process using the current image, according to the first division request from the processing-control unit 30. The details of the first dividing process are the same as the above.

FIG. 7B shows an example of the result of the first dividing process using the image shown in FIG. 7A. In the example of FIG. 7B, the area of the image shown in FIG. 7A is divided into a monochrome area 201, the color area 103, and a color area 202. In the first dividing process, first small areas 300 located across a boundary between the color image 200 and the monochrome image 100 are set. In the example of FIG. 7B, the first small areas 300 located across the above boundary are determined as color areas, and therefore an area that includes the area of the color image 200, and is larger than the color image 200 is determined as the color area 202. As a result, the area of a part of the monochrome image 100 is wrongly determined as a color area.

The first small areas 300 located across the above boundary are sometimes determined as a monochrome area. In this case, the area of a part of the color image 101 is wrongly determined as a monochrome area.

In a case where the color image includes some monochrome pixels, first small areas 300 including the monochrome pixels of the color image are sometimes wrongly determined as a monochrome area. In a case where the monochrome image includes some color pixels, first small areas 300 including the color pixels of the monochrome image are sometimes wrongly determined as a color area.

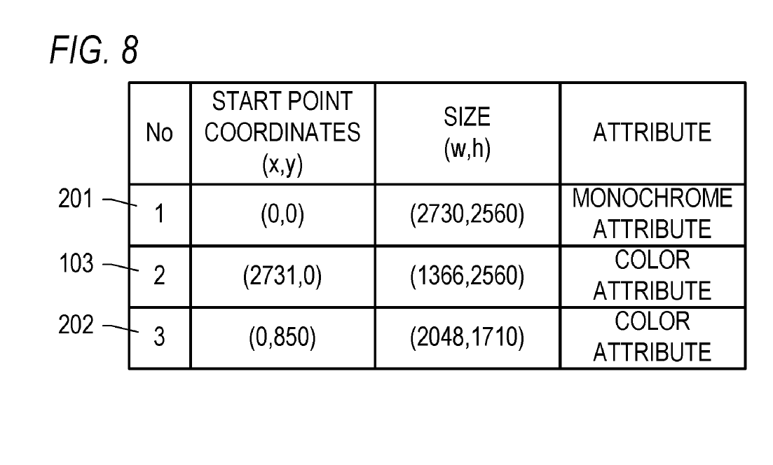

FIG. 8 shows an example of division result information 60 showing the monochrome area 201, the color area 103, and the color area 202. As shown in FIG. 8, as to the monochrome area 201, No.=1, start point coordinates (x, y)=(0, 0), size (w, h)=(2730, 2560), and attribute=monochrome attribute are shown. As to the color area 103, No.=2, start point coordinates (x, y)=(2731, 0), size (w, h)=(1366, 2560), and attribute=color attribute are shown. As to the color area 202, No.=3, start point coordinates (x, y)=(0, 850), size (w, h)=(2048, 1710), and attribute=color attribute are shown.

A rectangular area shown by the start point coordinates and the size sometimes overlaps with other rectangular area. An attribute of a rectangular area whose number is the largest among the plurality of overlapped rectangular areas is used for a superimposed area where a plurality of rectangular areas overlap with each other. In the example of FIG. 8, a rectangular area shown by start point coordinates (0, 850) and size (2048, 1710) includes a rectangular area shown by start point coordinates (0, 0) and size (2730, 2560). Then, No. 3 of the rectangular area shown by start point coordinates (0, 850) and size (2048, 1710) is larger than No. 1 of the rectangular area shown by start point coordinates (0, 0) and size (2730, 2560). As the attribute of the rectangular area shown by start point coordinates (0, 850) and size (2048, 1710), the color attribute that is the attribute of No. 3 is used. Then, as the attribute of an area obtained by excluding the rectangular area shown by start point coordinates (0, 850) and size (2048, 1710) from the rectangular area shown by start point coordinates (0, 0) and size (2730, 2560), the monochrome attribute that is the attribute of No. 1 is used.

Description will return to the description of FIG. 3.

Next to S302, the processing-control unit 30 determines whether or not the division completion notification is output from the area-division unit 10 (S303). In a case where the division completion notification is not output from the area-division unit 10 (S303: no), the processing-control unit 30 waits for the output of the division completion notification from the area-division unit 10. In a case where the division completion notification is output from the area-division unit 10 (S303: yes), the processing-control unit 30 outputs a differential determination request to the differential determination unit 40 (S304).

Next to S304, the processing-control unit 30 determines whether nor not the re-division request is output from the differential determination unit 40 (S305). In a case where the re-division request is not output from the differential determination unit 40 (S305: no), the process advances to S308. In a case where the re-division request is output from the differential determination unit (S305: yes), the process advances to S306.

Herein, it is assumed that the differential value the first threshold value or greater. Therefore, the process advances to S306.

In S306, the processing-control unit 30 outputs a second division request to the area-division unit 10 (S302). The area-division unit 10 performs a second dividing process using the current image according to the second division request from the processing-control unit 30. More specifically, the area-division unit 10 performs the second dividing process according to the second division request, so that the differential area is divided into a monochrome area and a color area. Then, the area-division unit 10 updates the division result of the current image by replacing the attribute of the differential area shown by the result of the first dividing process using the current image with the attribute of the differential area shown by a result of the second dividing process using the current image. Thereafter, the area-division unit 10 outputs a division completion notification showing that the second dividing process is completed, to the processing-control unit 30, and outputs division result information showing an updated division result, and the current image, to the gamma-correction unit 20. Additionally, the area-division unit 10 records the division result information 60 showing the updated division result in the storage unit 8.

The second dividing process will be described with reference to FIG. 9B.

In this embodiment, a process of dividing the area of an image into a monochrome area and a color area in units of the area of second size that is smaller than the first size is performed as the second dividing process.

First, the area-division unit 10 divides the differential area into a plurality of second small areas 301. More specifically, a second division parameter value is acquired from among the plurality of division parameter values 70, according to the second division request. In this embodiment, the second division parameter value shows “m2” which is the size of each of the second small areas 301 (second size). Then, the second small areas which are m2 [pixels]×m2 [pixels] squares are set. In this embodiment, it is assumed that the value of “m2” is 10 [pixels]. As described above, in this embodiment, the differential area is the area in which the attribute shown by the result of the first dividing process using the current image is different from the attribute shown by the division result of the past image. From FIG. 5B and FIG. 7B, it is found that, in the color area 202, the attribute shown by the result of the first dividing process using the current image is different from the attribute shown by the division result of the past image. Additionally, it is found that in each area other than the color area 202, the attribute shown by the result of the first dividing process using the current image coincides with the attribute shown by the division result of the past image. That is, from FIG. 5B and FIG. 7B, it is found that the color area 202 is the differential area, and the areas other than the color area 202 are not the differential areas. Therefore, as shown in FIG. 9B, the color area 202 is divided into the plurality of second small areas 301.

Next, the area-division unit 10 converts the pixel value (pixel value of an area that includes at least the differential area) of the current image from the value of the RGB color space into the value of the uniform perception color space.

Then, the area-division unit 10 determines whether the second small area is the monochrome area or the color area for each second small area, on the basis of an accumulated value of the perception chromaticity values of the pixel of the second small area.

Through the above processes, the differential area is divided into a monochrome area (area configured by one or more second small areas determined as a monochrome area) and a color area (area configured by one or more second small areas determined as a color area).

When the second dividing process is completed, the area-division unit 10 updates the division result of the current image, by replacing the attribute of the differential area shown by the result of the first dividing process using the current image, by the attribute of the differential area shown by the result of the second dividing process using the current image. Then, the area-division unit 10 outputs a division completion notification showing that the second dividing process is completed, to the processing-control unit 30, and outputs division result information showing an updated division result, and the current image, to the gamma-correction unit 20. Additionally, the area-division unit 10 records the division result information 60 showing the division result obtained after the update, in the storage unit 8.

The value of “m2” is favorably smaller than the value of “m1” and may be larger or smaller than 10 [pixels].

The shapes of the second small areas are not limited to squares. For example, the shapes of the second small areas may be rectangles.

A method of the second dividing process is not limited to the above method. For example, it may be determined whether each second small area is the monochrome area or the color area, on the basis of the total number of the monochrome pixels of the second small areas, the monochrome ratio of the second small area, the color ratio of the second small area, or the like.

The differential area may be larger or smaller than an area in which the attribute shown by the result of the first dividing process using the current image is different from the attribute shown by the division result of the past image. The differential area favorably includes the area in which the attribute shown by the result of the first dividing process using the current image is different from the attribute shown by the division result of the past image.

In a case where at least one of the horizontal size and the vertical size of the differential area is not an integral multiple of the value of “m2”, the value of “m2” is favorably adjusted such that the horizontal size and the vertical size of the differential area become the integral multiple of the value of “m2”. Additionally, the size of a part of the second small areas (e.g., second small areas corresponding to edge parts of the differential area) may be changed such that the size of the area configured from the plurality of second small areas coincides with the size of the differential area.

In this embodiment, the differential area is divided into the monochrome area and the color area by the second dividing process. However, the whole area of the current image may be divided into the monochrome area and the color area by the second dividing process. Then, the division result of the current image may be updated from the result of the first dividing process using the current image to the result of the second dividing process using the current image.

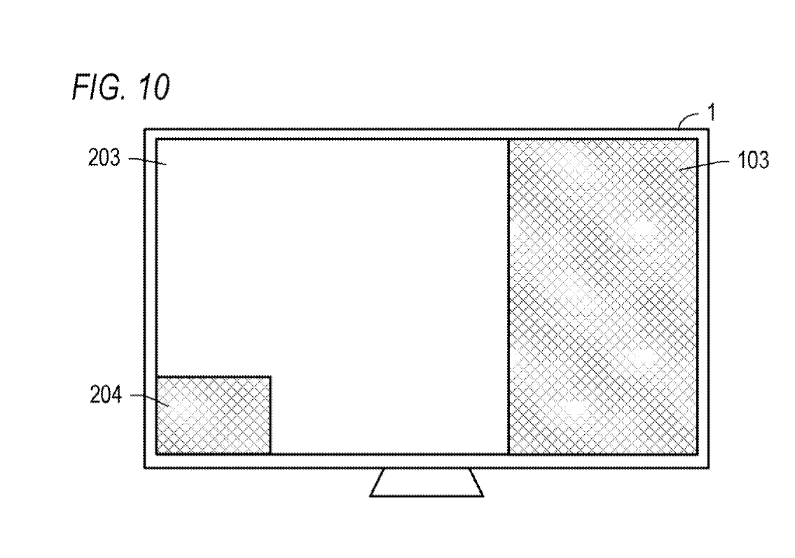

FIG. 10 shows an example of a division result reflecting the result of the second dividing process. From FIG. 10, it is found that a proper attribute is assigned to the area of each image. More specifically, it is found that the area of the monochrome image 100 is correctly determined as a monochrome area 203, the area of the color image 101 is correctly determined as a color area 103, and the area of the color image 200 is correctly area determined as a color area 204.

Description will return to the description of FIG. 3.

Next to S306, the processing-control unit 30 determines whether or not the division completion notification is output from the area-division unit 10 (S307). In a case where the division completion notification is not output from the area-division unit 10 (S307: no), the processing-control unit 30 waits for the output of the division completion notification from the area-division unit 10. In a case where the division completion notification is output from the area-division unit 10 (S307: yes), the processing-control unit 30 outputs a correction request to the gamma-correction unit 20. The gamma-correction unit 20 applies gamma correction to the current image according to the correction request from the control unit 7. The gamma-correction unit 20 applies gamma correction to the current image in accordance with the division result information output from the area-division unit 10. Herein, the gamma correction is individually applied to the monochrome area 203, the color area 103, and the color area 204 shown in FIG. 10, on the basis of the division result obtained after the update. Then, the gamma-correction unit 20 outputs an image obtained after the gamma correction, to the drive unit 4, and the drive unit 4 drives the panel 5 according to the image obtained after the gamma correction. Consequently, the image obtained after the gamma correction is displayed. At this time, the differential determination unit 40 reads division result information 60 showing the result obtained after the update, from the storage unit 8, and holds the read information as the division result of the past image.

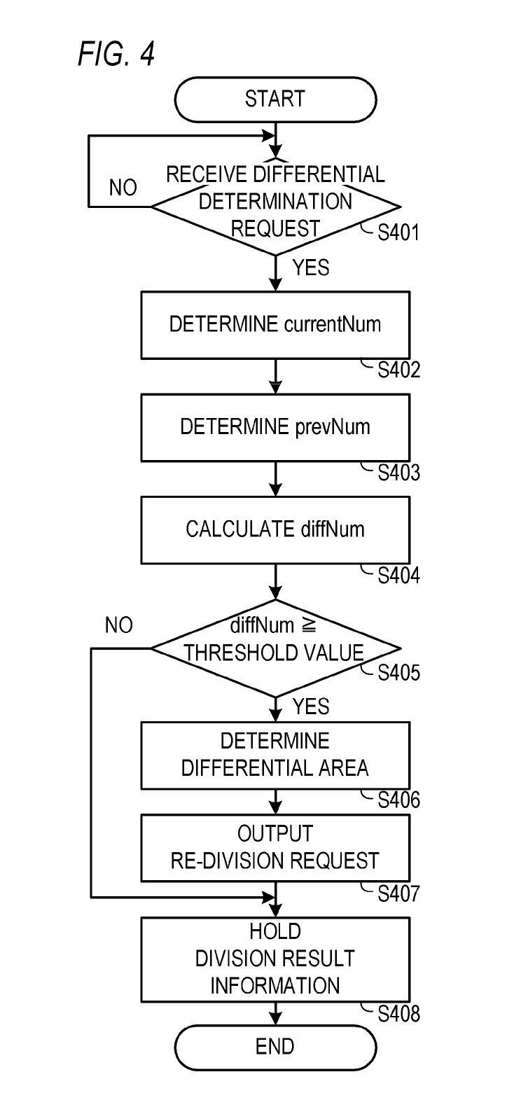

Now, an example of a processing flow of the differential determination unit 40 will be described with reference to a flowchart shown in FIG. 4.

The following description covers an example of a case where the past image is the image shown in FIG. 5A, and the current image is the image in FIG. 7A.

First, the differential determination unit 40 determines whether or not a differential determination request outputs from the processing-control unit 30 (S401). In case where the differential determination request is not output from the processing-control unit 30 (S401: no), the differential determination unit 40 waits for the output of the differential determination request from the processing-control unit 30. In case where the differential determination request is output from the processing-control unit 30 (S401: yes), the differential determination unit 40 determines the total number of the monochrome area and the color area shown by a result of the first dividing process using the current image, and substitutes the determined total number for a variable currentNum (S402). More specifically, the differential determination unit 40 acquires division result information 60 showing the result of the first dividing process using the current image, from the storage unit 8. Then, the differential determination unit 40 determines the total number of the monochrome area and the color area shown by the result of the first dividing process using the current image from the division result information 60. Thereafter, the differential determination unit 40 substitutes the determined total number for the variable currentNum. Herein, as shown in FIG. 7B, the area of the current image is divided into three division areas by the first dividing process using the current image. Therefore, variable currentNum=3 is obtained.

Next to S402, the differential determination unit 40 determines the total number of the monochrome area and the color area shown by the division result of the past image, and substitutes the determined total number for a variable prevNum (S403). More specifically, the differential determination unit 40 determines the total number of the monochrome area and the color area shown by the division result of the past image, from the held division result information (information showing the division result of the past image). Then, the differential determination unit 40 substitutes the determined total number for the variable prevNum. Herein, as shown in FIG. 5B, the division result of the past image shows the two division areas. Therefore, variable prevNum=2 is obtained.

The differential determination unit 40 calculates a differential value, and substitutes the calculated differential value for a variable diffNum (S404). In this embodiment, a difference between the total number of the monochrome area and the color area shown by the result of the first dividing process using the current image, and the total number of the monochrome area and the color area shown by the division result of the past image is calculated as the differential value. In this embodiment, |variable currentNum−variable prevNum| is calculated as the differential value. Herein, since currentNum=3 and prevNum=2 are established, diffNum=|3−2|=1 is obtained.

Then, the differential determination unit 40 determines whether the differential variable diffNum is the first threshold value or greater (S405). In a case where the differential variable diffNum is the first threshold value or greater (S405: yes), the process advances to S406. In a case where the differential variable diffNum is less than the first threshold value (S405: no), the process advances to S408. In this embodiment, it is assumed that first threshold value=1 is satisfied. Herein, the differential variable diffNum is 1, and the differential variable diffNum is the first threshold value=1 or more. Therefore, the process advances to S406.

The first threshold value may be greater than 1.

In S406, the differential determination unit 40 determines a differential area, and records differential area information 50 showing the determined differential area, in the storage unit 8.

In this embodiment, information including the number of the differential areas, and the position and the size of each differential area is recorded as the differential area information 50. As described above, herein, the color area 202 shown in FIG. 7B is determined as the differential area. Therefore, the number of the differential area=1, the position of the differential area (start point coordinates (x, y))=(0,850), and size (w, h)=(2048, 1710) are recorded as the differential area information 50.

Then, the differential determination unit 40 outputs a re-division request to the processing-control unit 30 (S407). Thereafter, the process advances to S408.

In S408, the differential determination unit 40 holds the division result information 60 as information showing the division result of the past image. More specifically, in a case where it is determined that the differential variable diffNum is less than the first threshold value in S405, the differential determination unit 40 holds the division result information 60 showing the result of the first dividing process, as the information showing the division result of the past image. In a case where it is determined that the differential variable diffNum is the first threshold value or greater in S405, the differential determination unit 40 waits for the recording of division result information 60 showing a division result reflecting the result of the second dividing process. Then, the differential determination unit 40 holds the division result information 60 showing the division result reflecting the result of the second dividing process, as the information showing the division result of the past image.

As described above, according to this embodiment, in a case where the differential value indicating the difference between the division result of the past image and the result of the first dividing process using the current image is the first threshold value or greater, the second dividing process having higher processing accuracy than the first dividing process is performed by using the current image. Then, the division result of the current image is updated from the result of the first dividing process using the current image to the result of the second dividing process using the current image. Consequently, the area of an image can be highly precisely divided into the monochrome area and the color area with a small load. More specifically, in a case where there is a high possibility that a wrong division result is obtained by the first dividing process, the second dividing process is performed, and therefore a more accurate division result can be obtained as a final division result. Additionally, the highly precise second dividing process is performed only when there is a high possibility that a wrong division result is obtained by the first dividing process. Therefore, a processing load can be reduced compared to a case where the second dividing process is performed for each frame. Additionally, according to this embodiment, the area of an image can be divided into the area monochrome area and the color area with high accuracy. That is, according to this embodiment, a highly reliable division result can be obtained as a final division result. Therefore, it is possible to reduce the frequency of the confirmation of the division result by user, and to reduce a burden on the user.

According to this embodiment, the second dividing process can be performed for only the differential area, and therefore the processing load can be further reduced. More specifically, a highly reliable division result can be obtained through processes, the number of which is reduced compared to a case where the second dividing process is performed for the whole area of a current image.

The display apparatus 1 may have a notification unit that notifies the user that the dividing process is performed. The notification unit notifies the user that the dividing process, for example, from when the process on a current image is performed until when the final division result of the current image is acquired. More specifically, the notification unit generates a message image such as “The division of an area is being performed. Please wait until the area is accurately divided.” from when the process on the current image is performed until when the final division result of the current image is acquired. The user is notified that the dividing process is being performed, by displaying the message image. The notification that the dividing process is being performed may be performed from when the second dividing process is performed until when the second dividing process is completed. That is, in a case where the second dividing process is not performed, the notification that the dividing process is being performed may not be performed.

In this embodiment, the second dividing process is performed every time it is determined that the differential value is the first threshold value or greater. However the timing of performing the second dividing process is not limited to this.

In the image-processing apparatus according to this embodiment (display apparatus 1), it is sometimes continued to be determined that the differential value is the first threshold value or greater in the periods of a plurality of frames.

For example, in a case where an image that is input to the display apparatus 1 is changed over a plurality of frames, determination determining that the differential value is the first threshold value or greater continues in the periods of the plurality of frames. Then, for a period during which the image input to the display apparatus 1 continuously changes, much importance is not accorded to image quality.

More specifically, user operation for changing the position of the monochrome image or the color image over the plurality of frames is sometimes performed in order to determine the arrangement of the monochrome image or the color image. In a case where such user operation is performed, it is sometimes continued to be determined that the differential value is the first threshold value or greater in the periods of the plurality of frames. However, image quality is not considered to be important during such user operation.

Therefore, the second dividing process may be performed at the timing of switching the differential value from a value of the first threshold value or greater to a value of not less than the first threshold value. Consequently, the execution frequency of the second dividing process can be further reduced, and therefore a processing load can be further reduced.

In this embodiment, the past image is a previous frame of the current frame. However, the past image is not limited to this. The past image is simply a frame prior to the current frame. For example, in a case where the dividing process is performed for each N frames (N is an integer of 1 or more), the past image may be a frame prior to the current frame by N frames.

In this embodiment, the second dividing process is the process of dividing the area of an image into the monochrome area and the color area in units of the area of the second size that is smaller than the first size. However, the second dividing process is not limited to this. For example, a plurality of large areas including the first small areas may be set, it may be determined whether or not each of the plurality of large areas is the monochrome area, and it may be determined whether or not the first small areas are the monochrome areas, on the basis of the determination results of the plurality of large areas.

### Second Embodiment

Hereinafter, an image-processing apparatus and an image-processing method according to a second embodiment of the present invention will be described.

In the following description, functions that are different from those of the first embodiment will be described in detail, and description of functions that are similar to those of the first embodiment will be omitted.

A configuration of a display apparatus according to this embodiment is the same as that of the first embodiment (FIG. 2).

In this embodiment, processes of a differential determination unit 40 are different from those of the first embodiment. In the first embodiment, a differential value is determined on the basis of the total number of division areas (color areas and monochrome areas) shown by a division result. In this embodiment, a differential value is determined on the basis of the size of division area shown by a division result.

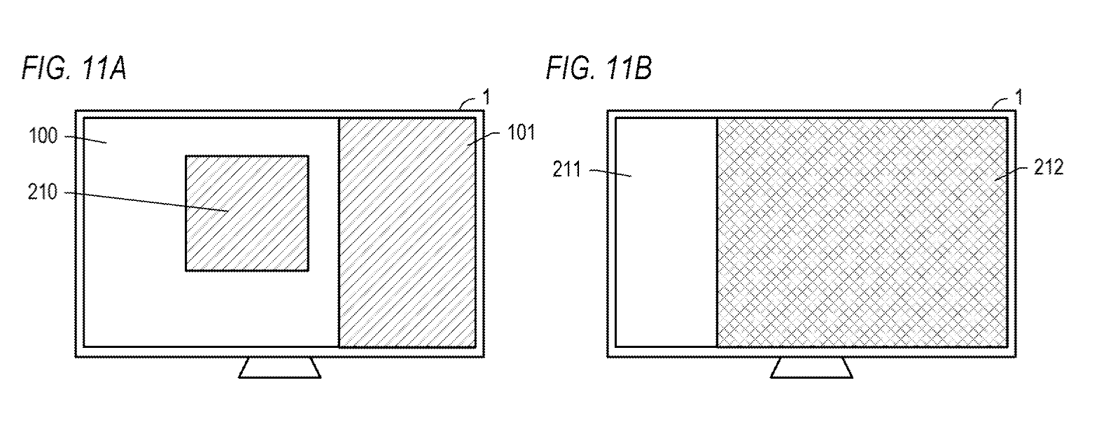

The following description covers a case where a past image is the image shown in FIG. 5A, and a current image is an image shown in FIG. 11A. The current image shown in FIG. 11A is an image obtained by superimposing a color image 210 on the image shown in FIG. 5A.

FIG. 11B shows an example of a result of a first dividing process using the image shown in FIG. 11A. In the example of FIG. 11B, the area of the image shown in FIG. 11A is divided into a monochrome area 211 and a color area 212. In the example of FIG. 11B, an area that includes the color image 101 and the color image 210 is determined as a color area 212. As a result, a part of the monochrome image 100 is wrongly determined as a color area.

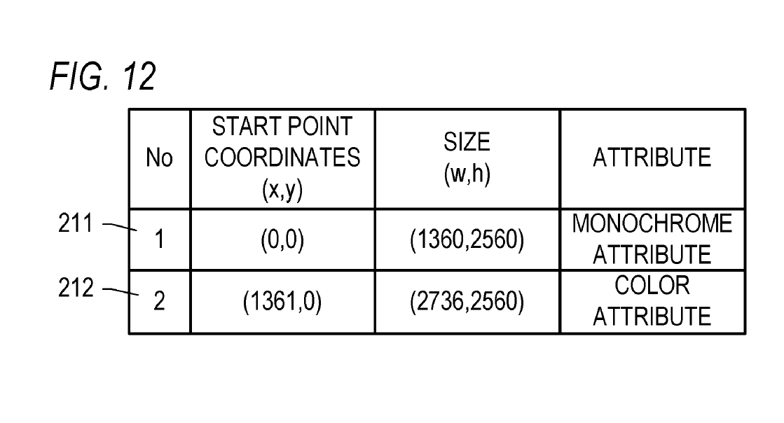

FIG. 12 shows an example of division result information 60 showing the monochrome area 211 and the color area 212. As shown in FIG. 12, as to the monochrome area 211, No.=1, start point coordinates (x, y)=(0, 0), size (w, h)=(1360, 2560), and attribute=monochrome attribute are shown. Then, as to the color area 212, No.=2, start point coordinates (x, y)=(1361, 0), size (w, h)=(2736, 2560), and attribute=color attribute are shown.

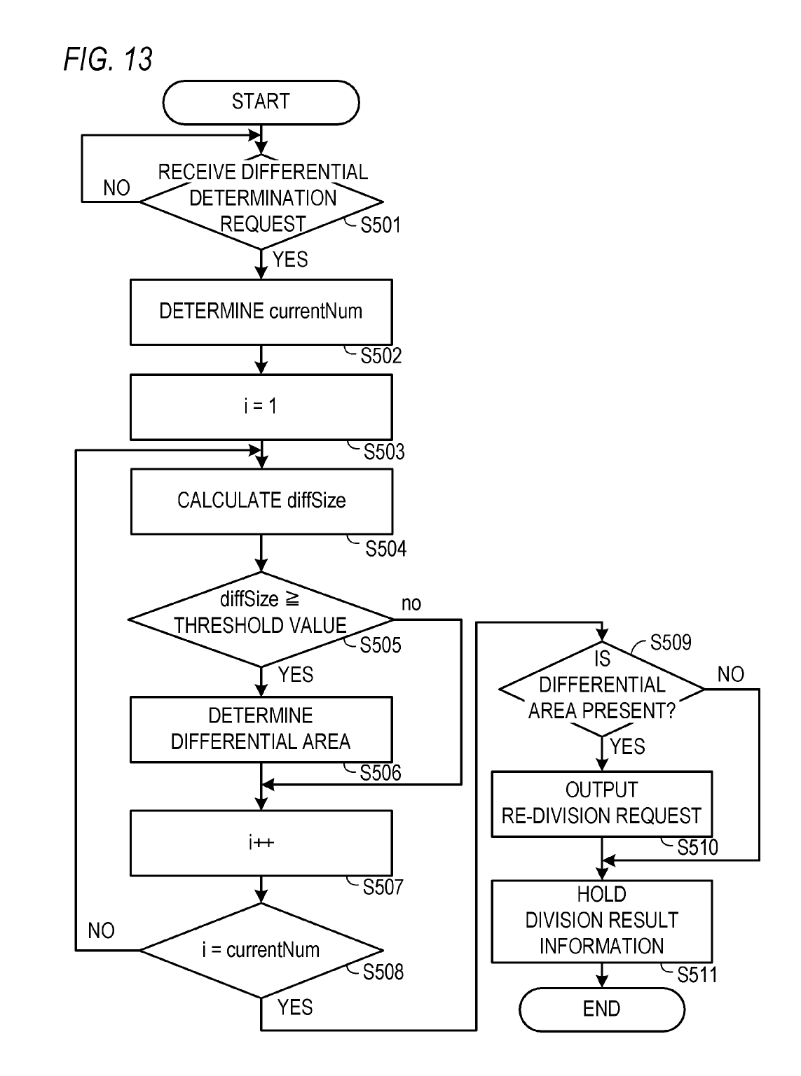

An example of a processing flow of the differential determination unit 40 according to this embodiment will be described with reference to a flowchart of FIG. 13.

Processes of S501 and S502 are similar to the processes of S401 and S402 of FIG. 4, and therefore description thereof will be omitted.

Next to S502, the differential determination unit 40 initializes a value of a variable i. In this embodiment, the value of the variable i is initialized to (S503).

As long as the value of the variable i is a value capable of identifying a division area, any value may be employed.

Then, the differential determination unit 40 calculates a differential value diffSize (S504).

More specifically, the differential value diffSize is calculated in the following steps.

The differential determination unit 40 determines division areas (a monochrome area and a color area) shown by a result of the first dividing process using the current image, from division result information 60 acquired in S502.

Additionally, the differential determination unit 40 determines a division area shown by a division result of the past image, from held division result information.

Then, the differential determination unit 40 selects a current division area as a division area whose number coincides with the value of the variable i, from among the division areas shown by the result of the first dividing process using the current image.

Additionally, the differential determination unit 40 selects a division area, to which attribute identical with attribute of the current division area is assigned, as a past division area, from among division areas shown by a division result of the past image. That is, the past division area is an area that satisfies the following Condition 1 and Condition 2:

Condition 1: an area shown by the division result of the past image; and

Condition 2: an area to which the attribute identical with the attribute of the current division area is assigned.

Then, the differential determination unit 40 calculates a difference between current division area size currentSize and past division area size prevSize as a differential value diffSize. In this embodiment, |size currentSize−size prevSize| is calculated as the differential value diffSize. The size currentSize, and the size prevSize each are, for example, a value obtained by multiplying a width by a height (dimensions).

In a case of i=2, the color area 212 shown in FIG. 11B is selected as the current division area, the color area 103 shown in FIG. 5B is selected as the past division area. The current division area size currentSize is width of 2736×height of 2560=7004160 [pixels], the past division area size prevSize is width of 1366×height of 2560=3496960 [pixels]. Therefore, |size currentSize−size prevSize|=|7004160−3496960|=3507200 [pixels] is calculated as the differential value diffSize.

In a case where a plurality of past division areas are present, the differential value is simply determined by using a past division area that is the closest to the current division area among the plurality of past division areas.

Next to S504, the differential determination unit 40 determines whether or not the differential value diffSize is a first threshold value or greater (S505). In a case where the differential value diffSize is the first threshold value or greater (S505: yes), the process advances to S506. In a case where the differential value diffSize is less than the first threshold value (S505: no), the process advances to S507. In this embodiment, it is assumed that the first threshold value=100 [pixels]. In a case of i=2, the differential value diffSize is 3507200 [pixels], the differential value diffSize is a value of the first threshold value=100 [pixels] or more. Therefore, the process advances to S506.

In S506, the differential determination unit 40 determines a differential area, and records differential area information 50 showing the determined differential area, in a storage unit 8.

In this embodiment, a current division area in which the differential value is the first threshold value or greater is determined as the differential area. Therefore, in the case of i=2, the color area 212 shown in FIG. 11B is determined as the differential area.

Similarly to the first embodiment, an area in which the attribute shown by the result of the first dividing process using the current image is different from the attribute shown by the division result of the past image may be determined as the differential area. For example, in the current division area, the area in which the attribute shown by the result of the first dividing process using the current image is different from the attribute shown by the division result of the past image may be determined as the differential area.

The differential determination unit 40 increments the value of the variable i by 1 (S507).

Then, the differential determination unit 40 determines whether or not processes of S504 to S507 are performed for all division areas shown by the result of the first dividing process using the current image (S508). In a case where the processes of S504 to S507 are not performed (S508: no), the process returns to S504. The process of S504 to S508 are repeatedly performed until the processes of S504 to S507 are performed for all division areas. In a case where the processes of S504 to S507 are performed for all division areas (S508: yes), the process advances to S509. More specifically, it is determined whether or not the value of the variable i coincides with the value of the variable currentNum. In a case where the value of the variable i is smaller than the value of the variable currentNum, it is determined that there is a division area to which the processes of S504 to S507 are not performed. In a case where the value of the variable i coincides with the value of the variable currentNum, it is determined that the processes of S504 to S507 are performed to all division areas.

In S509, the differential determination unit 40 determines whether or not the differential area is present. In a case where the differential area is present (S509: yes), the process advances to S510. In a case where the differential area is not present (S509: no), the process advances to S511.

In S510, the differential determination unit 40 outputs a re-division request to the processing-control unit 30. Thereafter, the process advances to S511.

In S511, the differential determination unit 40 holds division result information 60 as information showing the division result of the past image. More specifically, in a case where it is determined that the differential area is not present in S509, the differential determination unit 40 holds division result information 60 showing the result of the first dividing process as the division result of the past image. In a case where it is determined that the differential area is present in S509, the differential determination unit 40 waits the recording of division result information 60 showing a division result reflecting a result of a second dividing process. Then, the differential determination unit 40 holds the division result information 60 showing the division result reflecting the result of the second dividing process, as the information showing the division result of the past image.

Although not shown in the figure, the second dividing process is performed to the color area 212 shown in FIG. 11B by performing the above processes. As a result, a proper attribute is assigned to the area of each image. More specifically, the area of the monochrome image 100 is correctly determined as a monochrome area, the area of the color image 101 is correctly determined as a color area, and the area of the color image 210 is correctly determined as a color area.

As described above, according to this embodiment, in a case where the differential value indicating the difference between the division result of the past image and the result of the first dividing process using the current image is the first threshold value or greater, the second dividing process having higher processing accuracy than the first dividing process is performed by using the current image. Then, the division result of the current image is updated from the result of the first dividing process using the current image to the result of the second dividing process using the current image. Consequently, the area of an image can be highly precisely divided into the monochrome area and the color area with a small processing load, and the burden on a user can be reduced.

According to this embodiment, the difference between the size of the current division area and the size of the past division area is calculated as the differential value. Therefore, the area of an image can be highly precisely divided into the monochrome area and the color area with a small processing load, also in a case where the number of division areas shown by the division result of the past image is the same as the number of division areas shown by the result of the first dividing process using the current image.

### Third Embodiment

Hereinafter, an image-processing apparatus and an image-processing method according to a third embodiment of the present invention will be described. The third embodiment will be described.

In the following description, functions that are different from those of the first embodiment will be described in detail, and description of functions that are similar to those of the first embodiment will be omitted.

A configuration of a display apparatus according to this embodiment is the same as that of the first embodiment (FIG. 2).

In this embodiment, processes of a differential determination unit 40 are different from those of the first embodiment. In the first embodiment, a differential value is determined on the basis of the total number of division areas shown by a division result. In this embodiment, a differential value is determined on the basis of the number of monochrome pixels of a division area shown by a division result.

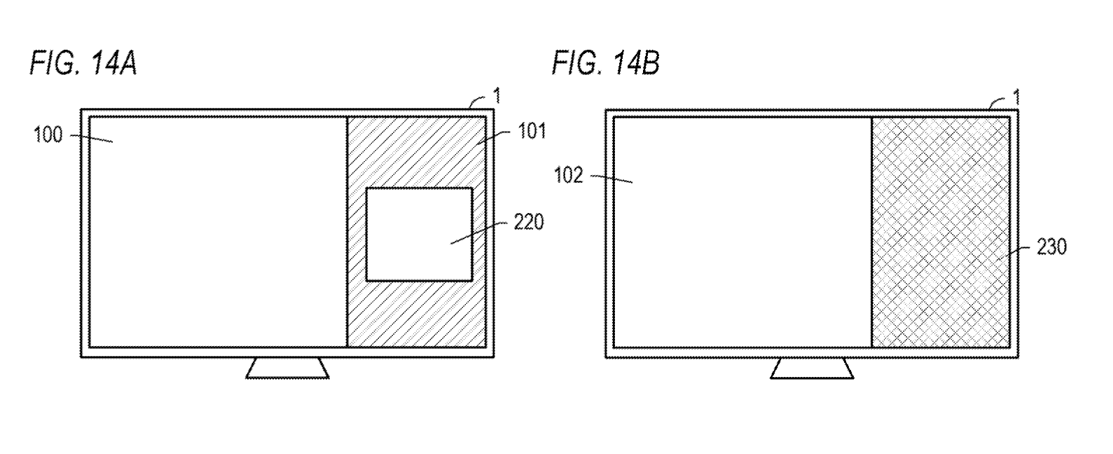

The following description covers a case where a past image is the image shown in FIG. 5A, and a current image is an image shown in FIG. 14A. The current image shown in FIG. 14A is an image obtained by superimposing a monochrome image 220 on the image shown in FIG. 5A.

FIG. 14B shows an example of a result of a first dividing process using the image shown in FIG. 14A. In the example of FIG. 14B, the area of the image shown in FIG. 14A is divided into the monochrome area 102 and the color area 230. In the example of FIG. 14B, the area that includes the color image 101 and the monochrome image 220 is determined as a color area 230. As a result, the whole area of the monochrome image 220 is wrongly determined as a color area.

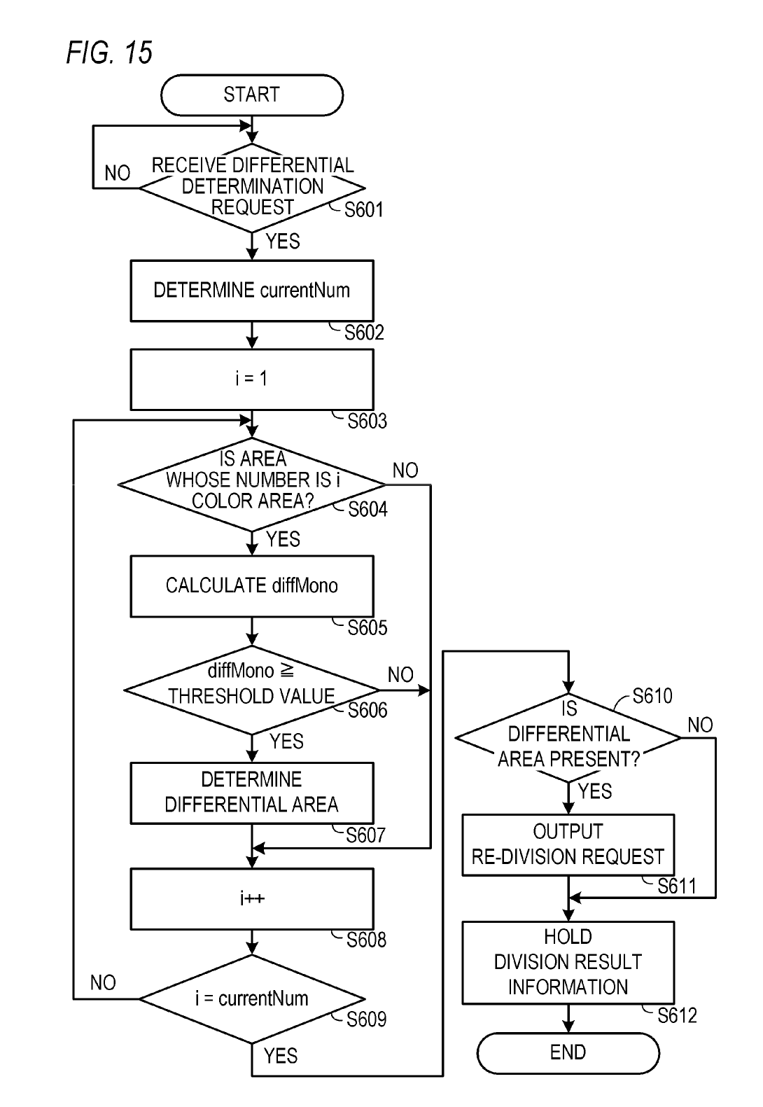

An example of a processing flow of the differential determination unit 40 according to this embodiment will be described with reference to a flowchart of FIG. 15.

Processes of S601 to S603 are similar to the processes of S501 to S503 of FIG. 13, and therefore description thereof will be omitted.

Next to S603, the differential determination unit 40 determines whether or not a division area whose number is coincides with a value of a variable i is a color area (current division area; current color area) (S604).

More specifically, a division area shown by a result of the first dividing process using the current image is determined from division result information 60 acquired in S602.

Next, the division area whose number is coincides with the value of the variable i is selected from among the result of the first dividing process using the current image.

Then, it is determined whether or not the selected division area is the color area.

In a case where the selected division area is the color area (S604: yes), the process advances S605. In a case where the selected division area is the monochrome area (S604: no), the process advances to S608.

In S605, the differential determination unit 40 calculates a differential value diffMono.

In this embodiment, a monochrome pixel change ratio between a color area (past division area:past color area) shown by a division result of the past image and the current color area is calculated as the differential value diffMono.

More specifically, the differential value diffMono is calculated in the following steps.

First, the differential determination unit 40 counts the total number of monochrome pixels of the current image in the current color area as the first total number currentMonoNum.

Additionally, the differential determination unit 40 determines the color area (past division area:past color area) showing the division result of the past image, from held division result information, and counts the total number of the monochrome image of the past image in the past color area, as the second total number pervMonoNum.

In this embodiment, the current image and the past image are recorded in a storage unit 8, and the differential determination unit 40 acquires the first total number and the second total number by using the current image and the past image recorded in the storage unit 8.

Then, the differential determination unit 40 calculates a ratio of a difference between the first total number currentMonoNum and the second total number pervMonoNum, to the total pixel number currentTotalNum of the current color area (size of the current color area), as the monochrome pixel change ratio. In this embodiment, (|currentMonoNum−pervMonoNum|/currentTotalNum)×100 is calculated as the monochrome pixel change ratio (differential value diffMono).

In a case of i=2, the color area 230 shown in FIG. 14B is selected as the current color area, and the color area 103 shown in FIG. 5B is selected as the past division area. The total pixel number currentTotalNum of the current color area is 3496960 [pixels]. Herein, when the first total number currentMonoNum is 1398784 [pixels], and the second total number pervMonoNum is 0 [pixel], the differential value diffMono=(|11398784−0|/3496960)×100=40 [%] is obtained.

In a case where a plurality of past division areas are present, the differential value is simply determined by using a past division area that is the closest to the current division area among the plurality of past division areas.

Next to S605, the differential determination unit 40 determines whether or not the differential value diffMono is a first threshold value or greater (S606). In a case where the differential value diffMono is the first threshold value or greater (S606: yes), the process advances to S607. In a case where the differential value diffMono is less than the first threshold value (S606: no), the process advances to S608. In this embodiment, it is assumed that first threshold value=30 [%] is satisfied. In the case of i=2, the differential value diffMono is 40 [%], the differential value diffMono is a value of the first threshold value=30 [%] or more. Therefore, the process advances to S607.

Processes of S607 to S612 are similar to the processes of S506 to S511 of FIG. 13, and therefore description thereof will be omitted.

Although not shown in the figure, the second dividing process is performed to the color area 230 shown in FIG. 14B by performing the above processes. As a result, a proper attribute is assigned to the area of each image. More specifically, the area of the monochrome image 100 is correctly determined as a monochrome area, the area of the color image 101 is correctly determined as a color area, and the area of the monochrome image 220 is correctly area determined as a monochrome area.

As described above, according to this embodiment, in a case where the differential value indicating the difference between the division result of the past image and the result of the first dividing process using the current image is the first threshold value or greater, the second dividing process having higher processing accuracy than the first dividing process is performed by using the current image. Then, the division result of the current image is updated from the result of the first dividing process using the current image to the result of the second dividing process using the current image. Consequently, the area of an image can be highly precisely divided into the monochrome area and the color area with a small processing load, and the burden on a user can be reduced.

According to this embodiment, the monochrome pixel change ratio is calculated as the differential value. Therefore, the area of an image can be highly precisely divided into the monochrome area and the color area with a small processing load, even in a case where the number of division areas shown by the division result of the past image is the same as the number of division areas shown by the result of the first dividing process using the current image. Additionally, the area of an image can be highly precisely divided into the monochrome area and the color area with a small processing load, even in a case where the size of the past division area and the size of the current division area are the same.

A color pixel change ratio may be calculated as the differential value. The color pixel change ratio is a ratio of a difference between the total number of color pixels of a current image in a current monochrome area (current division area) and the total number of color pixels of a past image in a past monochrome area (past division area), to the total pixel number of the current monochrome area. The current monochrome area is a monochrome area shown by the result of the first dividing process using the current image, and the past monochrome area is a monochrome area shown by the division result of the past image.

### Fourth Embodiment

Hereinafter, an image-processing apparatus and an image-processing method according to a fourth embodiment of the present invention will be described.

The description of this embodiment covers an example in which notification to a user is performed in a case where there is a high possibility that determination is wrongly performed regardless of the execution of a second dividing process.

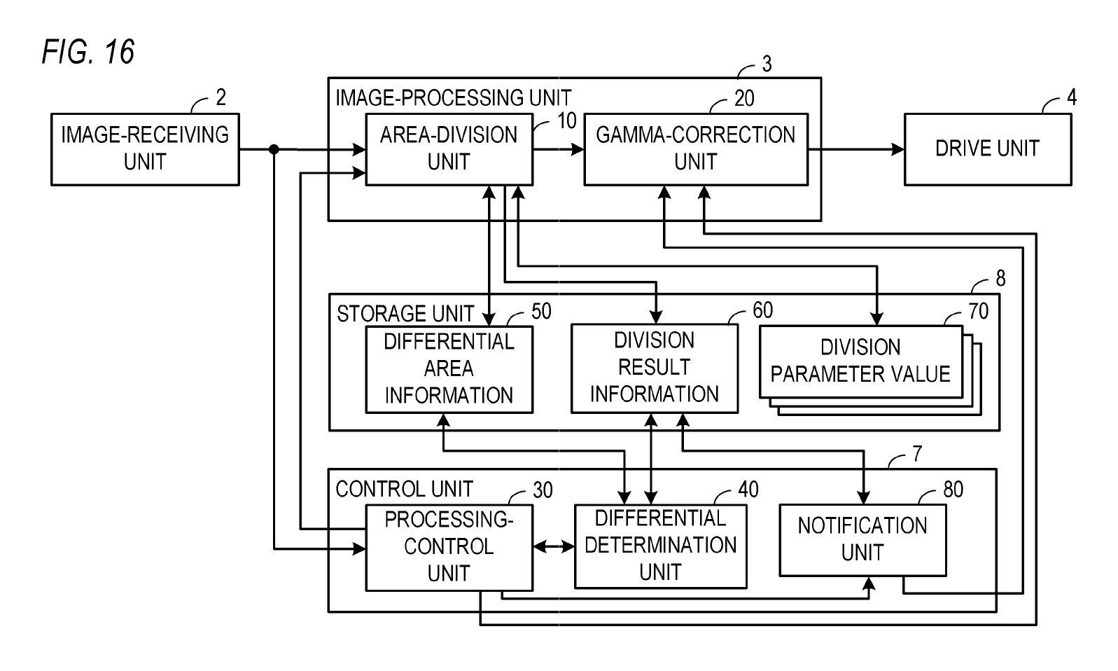

FIG. 16 is a function block diagram showing an example of a configuration of a display apparatus according to this embodiment. As shown in FIG. 16, the display apparatus according to this embodiment has a notification unit 80 in addition to the function unit of the first embodiment (FIG. 2). Additionally, a gamma-correction unit 20 and a processing-control unit 30 according to this embodiment have functions that are different from those of the first embodiment.

In FIG. 16, the functions of an image-receiving unit 2, an area-division unit 10, a differential determination unit 40, a storage unit 8, and a drive unit 4 are similar to those of the first embodiment, and therefore description thereof will be omitted.

The processing-control unit 30 according to this embodiment has the same function as that of the first embodiment. Furthermore, when acquiring a division completion notification showing that a second dividing process is completed, the processing-control unit 30 according to this embodiment outputs the acquired division completion notification.

The notification unit 80 notifies various kinds of information to a user. In this embodiment, the notification unit 80 generates a notification image showing information to be notified to the user. The information is notified to the user by displaying the notification image.

In this the embodiment, the notification unit 80 determines whether or not notification is performed, after the processing flow of FIG. 3 is terminated. The notification unit 80 determines whether or not the notification is performed, according to the division completion notification from the processing-control unit 30. Then, in a case where the notification needs to be performed, the processing-control unit 30 generates a notification image, and outputs the generated notification image. In this embodiment, whether or not the notification is needed is determined by using division result information (information showing a division result reflecting a result of the second dividing process), and the details of this will be later described.

A notification method to the user is not limited to the above method. For example, the information may be notified to the user by the generation of voice. Various information can be notified to the user by changing voice. Additionally, the information may be notified to the user by lighting a lamp. Various information can be notified to the user by changing a lighting color or a flashing pattern.

The gamma-correction unit 20 according to this embodiment has a function similar to that of the gamma-correction unit 20 of the first embodiment. Furthermore, in a case where the notification image is output from the notification unit 80, the gamma-correction unit 20 according to this embodiment generates a synthetic image obtained by superimposing the notification image on an image obtained after gamma correction, and outputs a synthetic image to the drive unit 4.

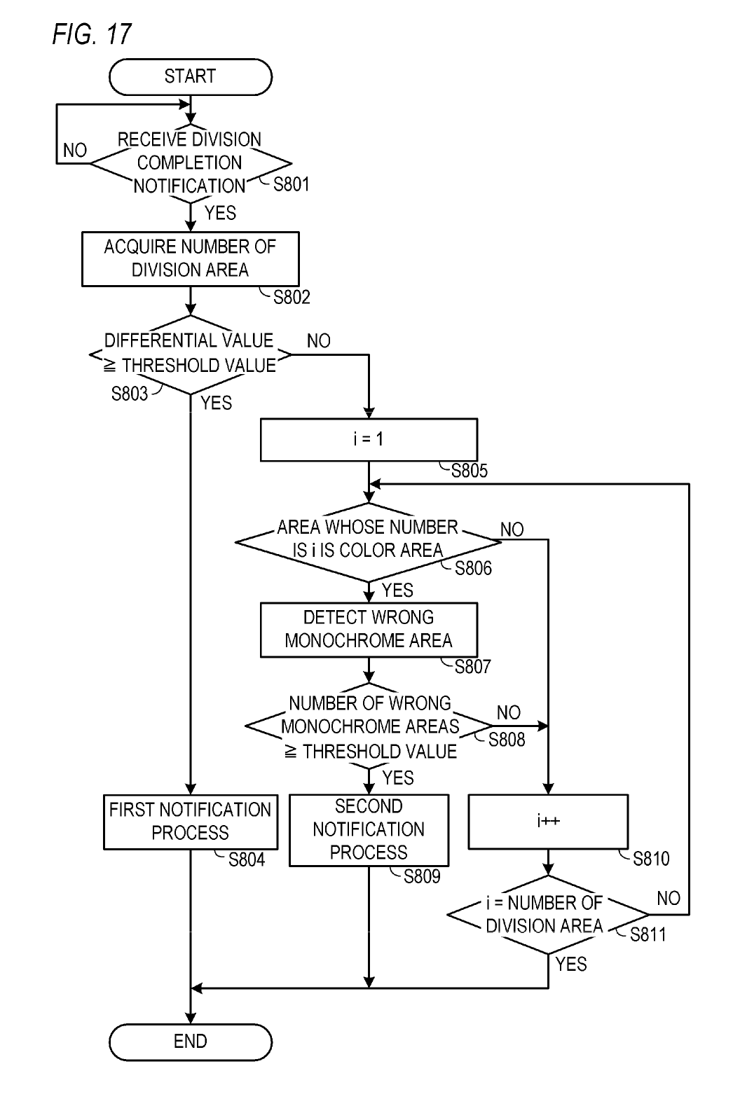

An example of a processing flow of the notification unit 80 will be described with reference to a flowchart of FIG. 17.

First, the notification unit 80 determine whether or not a division completion notification is output from the processing-control unit 30 (S801). In a case where the division completion notification is not output from the processing-control unit 30 (S801: no), the notification unit 80 waits for the output of the division completion notification from the processing-control unit 30. In a case where the division completion notification is output from the processing-control unit 30 (S801: yes), the notification unit 80 acquires the number of division areas shown by a division result obtained after the update of a current image (division result reflecting the result of the second dividing process), from the division result information 60 (S802).

Next to S802, the notification unit 80 determines whether or not a differential value indicating a difference between the division result obtained after the update of the current image and a division result of the past image is a second threshold value or greater (S803). In a case where the differential value is the second threshold value or greater (S803: yes), the process advances to S804. In a case where the differential value is less than the second threshold value (S803: no), the process advances to S805.

The second threshold value may be a fixed value that is preset by a manufacturer or the like, or may be a value that is changeable by a user. The second threshold value may be a value that is the same as the first threshold value, or may be a value that is different from the first threshold value.

In this embodiment, the differential value is calculated by the method described in the first embodiment. More specifically, a difference between the number of the division areas acquired in S802 and the total number of the division areas shown by the division result of the past image is calculated as the differential value.

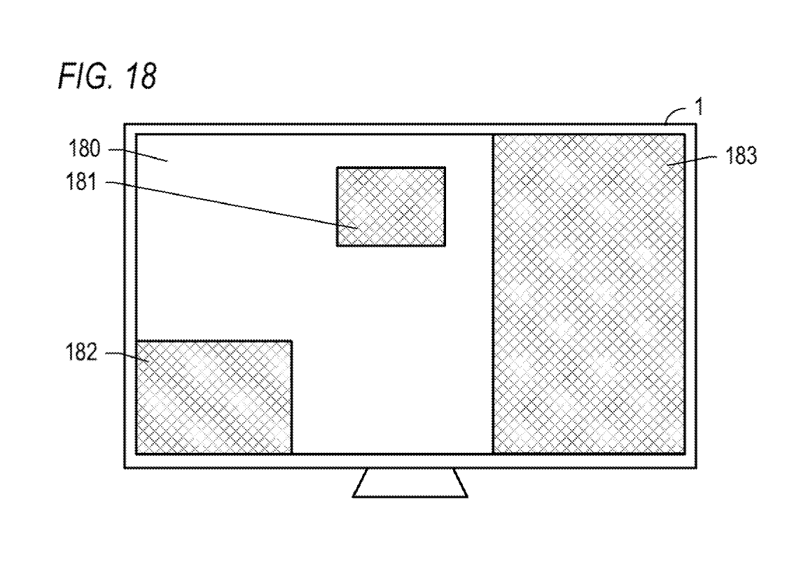

FIG. 18 shows an example of the division result obtained after the update of the current image. In the example of FIG. 18, the area of the current image is divided into four division areas, namely a monochrome area 180, and color areas 181, 182 and 183. In a case where the division result of the past image is the division result shown in FIG. 5B, the total number of the division areas shown by the division result of the past image is 2, and therefore 4−2=2 is obtained as the differential value. In a case where the second threshold value is 2, the differential value=2 is a value of the second threshold value=2 or more, and therefore the process advances to S804.

In S804, the notification unit 80 notifies the user of notification information indicating that there is a possibility that the division result obtained after the update of the current image is wrong (first notification process). In this embodiment, first notification information indicating at least one of the monochrome area and the color area shown by the division result obtained after the update of the current image is notified to the user as the notification information by the first notification process. More specifically, the notification unit 80 generates a notification image indicating at least one of the monochrome area and the color area shown by the division result obtained after the update of the current image, and outputs the generated notification image. As a result, a synthetic image obtained by superimposing the notification image is displayed. The notification image showing the division area is an image that has the outline of the division area, an image that covers the division area, or the like. Such a notification image is displayed, so that the user can grasps how the area of the current image is divided into division areas. Ina case where the division result is wrong, the user simply corrects the division result manually.

In S805, the notification unit 80 initializes a value of a variable i to 1.

Then, the notification unit 80 determines whether or not a division area of No. i shown by the division result obtained after the update of the current image is the color area (S806). In a case where the division area of No. i is the color area (S806: yes), the process advances to S807. In a case where the division area of No. i is not the color area (S806: no), the process advances to S810.

In S807, the notification unit 80 detects a wrong monochrome area by using the division result information 60. The wrong monochrome area is an area that may have been wrongly determined as a monochrome area, and satisfies the following Conditions 3 to 5:

Condition 3: an area in a color area of No. i;

Condition 4: a monochrome area shown by the division result obtained after the update of the current image; and

Condition 5: an area that has the size of a fourth threshold value or greater.

The fourth threshold value may be a fixed value that is preset by a manufacturer or the like, or may be a value that is changeable by a user.

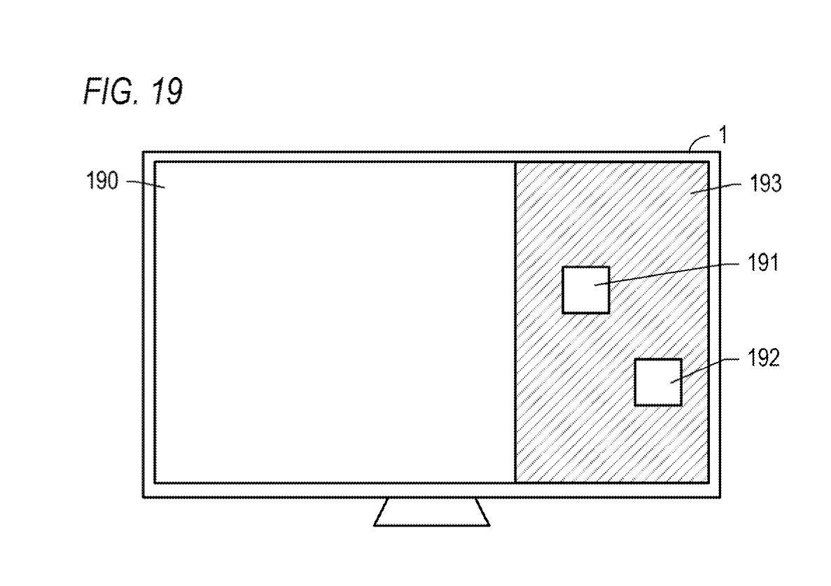

FIG. 19 shows an example of the division result obtained after the update of the current image. In the example of FIG. 19, the area of the current image is divided into four division areas, namely monochrome areas 190, 191 and 192, and a color area 193. In a case where the color area 193 is the color area of No. i, the monochrome areas 191 and 192 are monochrome areas in the color area 193, and therefore satisfy Conditions 3 and 4. In a case where the fourth threshold value is 100 [pixels], and the total pixel number of the monochrome area 191 and the total pixel number of the monochrome area 192 each are 100 [pixels] or more, the monochrome areas 191 and 192 also satisfy Condition 5. As a result, the monochrome areas 191 and 192 are detected as the wrong monochrome areas.

As the fourth threshold value, a threshold value of the width of the division area, and a threshold value of the height of the division area may be prepared. For example, in a case where the both of the width and the height is 10 [pixels] or more, it may be determined that Condition 5 is satisfied. The threshold value of the width and the threshold value of the height may be different from each other.

Next to S807, the notification unit 80 determines whether or not the number of the wrong monochrome areas detected in S807 is a third threshold value or greater (S808). In a case where the number of the wrong monochrome areas is the third threshold value or greater (S808: yes), the process advances to S809. In a case where the number of the wrong monochrome areas is less than the third threshold value (S808: no), the process advances to S810.

In a case where the third threshold value is 2, and the two monochrome areas 191 and 192 shown in FIG. 19 are detected as the wrong monochrome area, the number of wrong monochrome areas=2 is a value of the second threshold value=2 or more, and therefore the process advances to S809.

The third threshold value may be a fixed value that is preset by a manufacturer or the like, or may be a value that is changeable by a user.

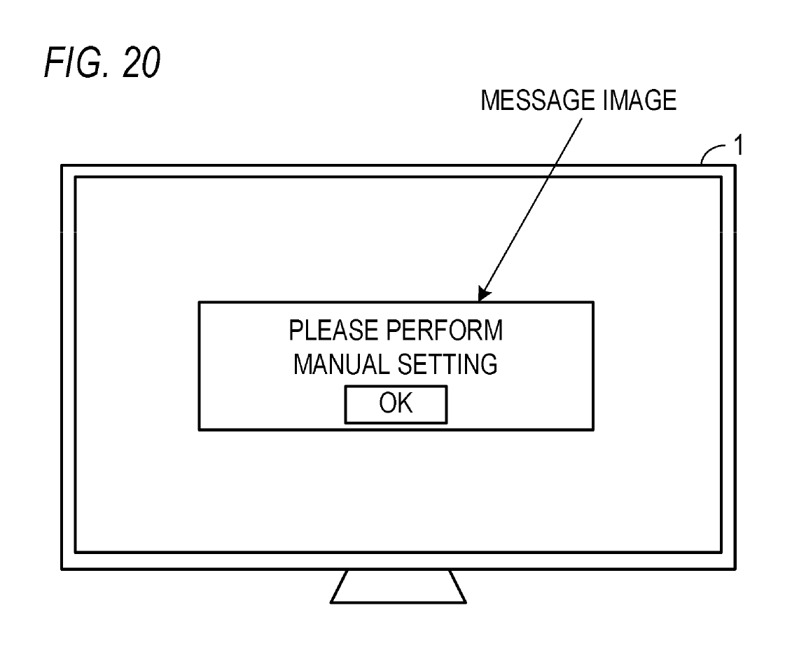

In S809, notification information indicating that there is a possibility that the division result obtained after the update of the current image is wrong is notified to the user (second notification process). In this embodiment, second notification information indicating that the monochrome area and the color area should be set manually is notified to the user as the notification information by the second notification process. More specifically, the notification unit 80 generates a notification image indicating that the monochrome area and the color area should be set manually, and outputs the generated notification image. As a result, a synthetic image obtained by superimposing the notification image is displayed. The notification information indicating that the monochrome area and the color area should be set manually is, for example, a message image shown in FIG. 20. In the example of FIG. 20, “please set manually” is described in the message image. Such a message image is displayed, so that the manual setting of the monochrome area and the color area can be urged to the user.

In S810, the notification unit 80 increments the value of the variable i by 1.

Then, the notification unit 80 determines whether or not processes of S806 to S810 are performed for all division areas shown by the division result obtained after the update of the current image (S811). In a case where there is a division area to which the processes of S806 to S810 are not performed (S811: no), the process returns to S806. Then, when the processes of S806 to S810 are performed for all division areas (S811: yes), the notification is not performed to the user, and this processing flow is terminated. More specifically, it is determined whether or not the value of the variable i coincides with a value of the number j of the division areas (the number of the division areas shown by the division result obtained after the update of the current image). In a case where the value of the variable i is smaller than the value of the number j of the division areas, it is determined that there is a division area to which the processes of S806 to S810 are not performed. In a case where the value of the variable i coincides with the value of the number j of the division areas, it is determined that a division area to which all the processes of S806 to S810 are performed for all division areas.

As described above, according to this embodiment, in a case where there is a high possibility that the division result obtained after the update of the current image is wrong regardless of the execution of a second dividing process, the user is notified that there is the high possibility that the division result obtained after the update of the current image is wrong. Consequently, the user can grasp that there is a possibility that the division result may wrong, and can be urged to the manual setting of the monochrome area and the color area.

In this embodiment, the differential value indicating the difference between the division result obtained after the update of the current image and the division result of the past image is determined by the method described in the first embodiment. However, the determination method of the differential value is not limited to this. For example, the differential value may be determined on the basis of the size of the division area, the monochrome pixel number of the division area, the color pixel number of the division area by the method described in the second and third embodiments.

A notification process other than the first notification process and the second notification process may be performed. For example, in a case where wrong color areas, the number of which is a fifth threshold value or greater, are present, a third notification process of notifying the user of notification information indicating that there is a possibility that the division result obtained after the update of the current image is wrong may be performed. The wrong monochrome area is an area that satisfies all of the following Conditions 6 to 8. In the third notification process, for example, at least one of the first notification information and the second notification information is notified.

Condition 6: an area in a monochrome area shown by the division result obtained after the update of the current image

Condition 7: a color area shown by the division result obtained after the update of the current image

Condition 8: an area that has the size of a sixth threshold value or greater

The fifth threshold value and the sixth threshold value each may be a fixed value that is preset by a manufacturer or the like, or may be a value that is changeable by a user.

The first notification process, the second notification process, and the third notification process may be performed by respective function units that are different from each other.

The second notification information may be notified by the first notification process. The second notification information may be notified by the second notification process. Both of the first notification information and the second notification information may be notified by the first notification process. Both of the first notification information and the second notification information may be notified by the second notification process.

### Fifth Embodiment

Hereinafter, an image-processing apparatus and an image-processing method according to a fifth embodiment of the present invention will be described.

In the following description, functions that are different from those of the fourth embodiment will be described in detail, and description of functions that are similar to those of the fourth embodiment will be omitted. The description of the fourth embodiment covers the example in which notification to a user is performed in a case where there is a high possibility that determination is wrongly performed regardless of the execution of a second dividing process. The description of this embodiment covers an example in which a division result obtained after an update is further updated in a case where there is a high possibility that determination is wrongly performed regardless of the execution of a second dividing process.

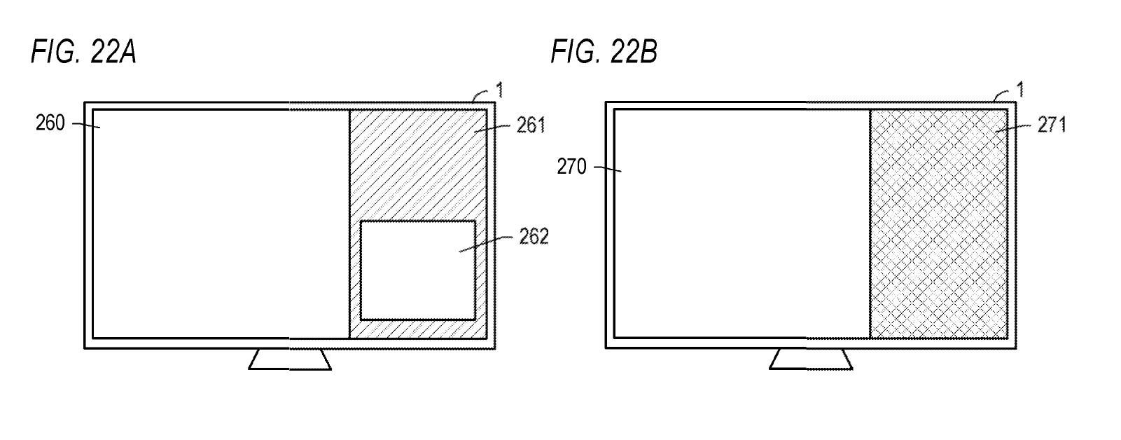

The following description covers an example in a case where a current image is an image in FIG. 22A. The current image shown in FIG. 22A is an image in which a monochrome image 260, a color image 261, and a monochrome image 262 are arranged. The monochrome image 262 is arranged in the area of the color image 261. In other words, the monochrome image 262 is superimposed on the color image 261.

FIG. 22B shows an example of a division result obtained after the update of the current image shown in FIG. 22A. In the example of FIG. 22B, the area of the image shown in FIG. 22A is divided into a monochrome area 270 and a color area 271. In the example of FIG. 22B, an area that includes the color image 261 and the monochrome image 262 is determined as a color area 271. As a result, the whole area of the monochrome image 262 is wrongly determined as a color area. Herein, it is assumed that the number of the monochrome area 270 is 1, the number of the color area 271 is 2.

In this embodiment, the processes of a notification unit 80 are different from those of the fourth embodiment.

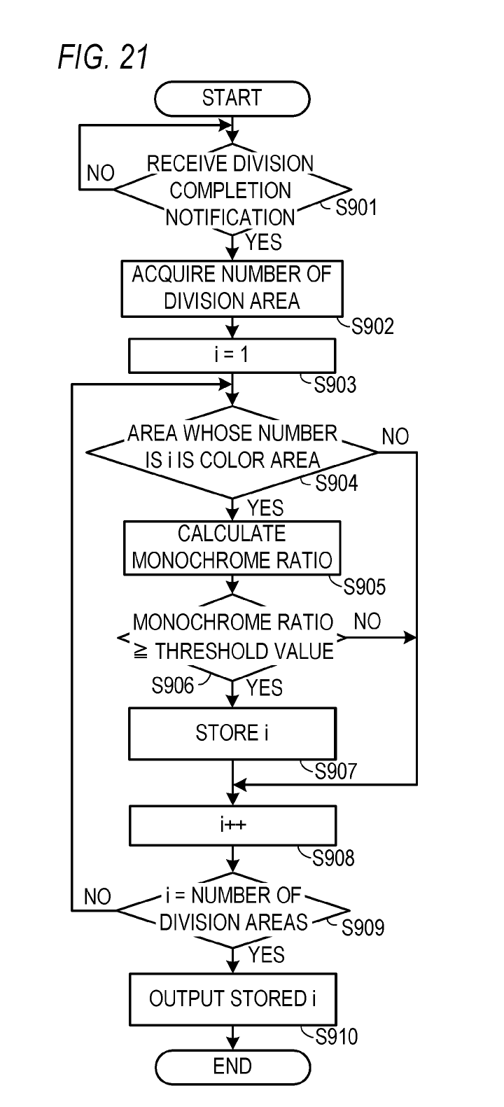

An example of a processing flow of the notification unit 80 according to this embodiment will be described with reference to a flowchart of FIG. 21.

Processes of S901 to S904 are similar to the processes of S801, S802, S805, and S806 of FIG. 17, and therefore description thereof will be omitted. In a case where a division area of No. i shown by the division result obtained after the update of the current image is the color area (S904: yes), the process advances from S904 to S905. In a case where the division area of No. i shown by the division result obtained after the update of the current image is not the color area (S904: no), the process advances from S904 to S908.

In S905, the notification unit 80 calculates a monochrome ratio of a color area of No. i (color area shown by the division result obtained after the update of the current image). The monochrome ratio is a ratio of the total number of monochrome pixels of a current image in a color area of No. i, to the total pixel number of the color area of No. i. More specifically, (total number of monochrome pixels of color area of No. i/total pixel number of color area of number i)×100 [%] is calculated as the monochrome ratio. In this embodiment, it is assumed that a monochrome ratio of the color area 271 of No. 2 is 40 [%].

Then, the notification unit 80 determines whether or not the monochrome ratio calculated in S905 is a seventh threshold value or greater (S906). In a case where the monochrome ratio is the seventh threshold value or greater (S906: yes), the process advances to S907. In a case where the monochrome ratio is less than the seventh threshold value (S906: no), the process advances to S908. In a case of seventh threshold value=30 [%], and variable i=2, monochrome ratio of color area 271 of No. 2=40 [%] is a value of seventh threshold value=30 [%] or more, and therefore the process advances to S907.

The seventh threshold value may be a fixed value that is preset by a manufacturer or the like, or may be a value that is changeable by a user.

In S907, the notification unit 80 stores a value of the variable i.

Processes of S908 and S909 are similar to the processes of S810 and S811 of FIG. 17, and therefore description thereof will be omitted. Ina case where there is a division area to which the process of S904 to S908 are not performed (S909: no), the process returns to S904. Then, the processes of S904 to S908 are repeatedly performed until the processes of S904 to S908 are performed for all division areas. In a case where the processes of S904 to S908 are performed for all division areas (S909: yes), the process advances to S910.

In S910, the notification unit 80 outputs the value of the variable i stored in S907 to a gamma-correction unit 20 as attribute modified area information. In a case where the division result obtained after the update of the current image is a division result shown in FIG. 22B, No. 2 of the color area 271 is output to the gamma-correction unit 20 as the attribute modified area information.

In a case where the attribute modified area information is output from the notification unit 80, the gamma-correction unit 20 performs gamma correction after replacing a color area of a number shown by the attribute modified area information with the monochrome area. That is, in this embodiment, in a case where a monochrome ratio of a color area shown by the division result obtained after the update of the current image is the seventh threshold value or greater, the division result obtained after the update of the current image is further updated by replacing the color area with the monochrome area. Then, gamma correction is performed in accordance with a division result after obtained after the re-update of the current image. In a case where the division result obtained after the update of the current image is the division result shown in FIG. 22B, the color area 271 is replaced by the monochrome area, and the whole area of the current image is determined as a monochrome area. Then, DICOM gamma correction is applied to the whole area of the current image. As a result, proper gamma correction can be applied to a monochrome image that is present in the color image, and the monochrome image can be displayed with proper image quality.

As described above, according to this embodiment, in a case where the monochrome ratio of the color area shown by the division result obtained after the update of the current image is the seventh threshold value or greater, the division result obtained after the update of the current image is further updated by replacing the color area with the monochrome area. Consequently, it is possible to obtain a division result in which a proper attribute is assigned to the area of the monochrome image arranged in the color image. As a result, a proper image process can be applied to the monochrome image arranged in the color image.

In a case where a color ratio of a monochrome area shown by the division result obtained after the update of the current image is an eighth threshold value or greater, the division result obtained after the update of the current image may be further updated by replacing the monochrome area with the color area. The color ratio is a ratio of the total number of color pixels of a current image in the monochrome area shown by the division result obtained after the update of the current image, to the total pixel number of the monochrome area. Consequently, it is possible to obtain a division result in which a proper attribute is assigned to the area of the color image arranged in the color image. As a result, a proper image process can be applied to the color image arranged in the monochrome image.

The eighth threshold value may be a fixed value that is preset by a manufacturer or the like, or may be a value that is changeable by a user.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-010316, filed on Jan. 23, 2014, which is hereby incorporated by reference herein in its entirety.

What is claimed is:

1. An image-processing apparatus comprising:
an input unit configured to input an image; and
an area-determination unit configured to determine a monochrome area and a color area by performing a first determination process on the input image, wherein
the area-determination unit determines a monochrome area and a color area by performing a second determination process, whose processing accuracy is higher than that of the first determination process, on the input image in a case where magnitude of temporal change of a result of the first determination process is a first threshold value or greater.

2. The image-processing apparatus according to claim 1, further comprising
a differential-determination unit configured to determine a differential value indicating a difference between a result of the first determination process with respect to an input first image, and a result of the first determination process with respect to a second image that is an image input prior to the first image, wherein
the area-determination unit determines that the magnitude of the temporal change of the result of the first determination process is the first threshold value or greater, in a case where the differential value is the first threshold value or greater.

3. The image-processing apparatus according to claim 1, wherein
the area-determination unit performs the second determination process on a differential area that includes an area, in which the result of the first determination process temporally changes, in a case where the magnitude of the temporal change of the result of the first determination process is the first threshold value or greater.

4. The image-processing apparatus according to claim 1, wherein
the first determination process is a process of determining a monochrome area and a color area in units of an area of first size, and
the second determination process is a process of determining a monochrome area and a color area in units of an area of second size that is smaller than the first size.

5. The image-processing apparatus according to claim 2, wherein
the second image is an image of an immediately preceding frame of the first image.

6. The image-processing apparatus according to claim 2, wherein
the area-determination unit performs the second determination process at timing of switching the differential value from a value of the first threshold value or greater to a value of less than the first threshold value.

7. The image-processing apparatus according to claim 2, wherein
the differential value is a difference between the total number of a monochrome area and a color area shown by the result of the first determination process on the first image, and the total number of a monochrome area and a color area shown by the result of the first determination process on the second image.

8. The image-processing apparatus according to claim 2, wherein
the differential value is a difference between a size of a first determination area that is a monochrome area or a color area shown by the result of the first determination process on the first image, and a size of a second determination area that is an area satisfying both Condition 1 and Condition 2 as follows:
Condition 1: a monochrome area or a color area shown by the result of the first determination process on the second image; and
Condition 2: an area in which the result of the first determination process on the second image is equal to the result of the first determination process on the first determination area of the first image.

9. The image-processing apparatus according to claim 2, wherein
the differential value is a ratio of a difference between the total number of monochrome pixels of the first image in a first determination area that is a color area shown by the result of the first determination process on the first image and the total number of monochrome pixels of the second image in a second determination area that is a color area shown by the result of the first determination process on the second image, to the total pixel number of the first determination area.

10. The image-processing apparatus according to claim 2, wherein
the differential value is a ratio of a difference between the total number of color pixels of the first image in a first determination area that is a monochrome area shown by the result of the first determination process on the first image and the total number of color pixels of the second image in a second determination area that is a monochrome area shown by the result of the first determination process on the second image, to the total pixel number of the first determination area.

11. The image-processing apparatus according to claim 2, further comprising
a first notification unit configured to notify a user of notification information indicating that there is a possibility that a result of the second determination process on the first image is wrong, in a case where a differential value indicating a difference between the result of the second determination process on the first image and the result of the first determination process on the second image is a second threshold value or greater.

12. The image-processing apparatus according to claim 1, further comprising
a second notification unit configured to notify a user of notification information indicating that there is a possibility that a result of the second determination process on the input image is wrong, in a case where the number of wrong monochrome areas is a third threshold value or greater, with the wrong monochrome area satisfying all of Condition 3 to 5 as follows:
Condition 3: an area in a color area shown by the result of the second determination process on the input image;
Condition 4: a monochrome area shown by the result of the second determination process on the input image; and
Condition 5: an area that has a size of a fourth threshold value or greater.

13. The image-processing apparatus according to claim 1, further comprising
a third notification unit configured to notify a user of notification information indicating that there is a possibility that a result of the second determination process on the input image is wrong, in a case where the number of wrong color areas is a fifth threshold value or greater, with the wrong color area satisfying all of Condition 6 to 8 as follows:
Condition 6: an area in a monochrome area shown by the result of the second determination process on the input image;
Condition 7: a color area shown by the result of the second determination process on the input image; and
Condition 8: an area that has a size of a sixth threshold value or greater.

14. The image-processing apparatus according to claim 2, wherein
in a case where a ratio of the total number of monochrome pixels of the first image in a color area shown by the result of the second determination process on the first image, to the total pixel number of the color area is a seventh threshold value or greater, the area-determination unit determines the color area as a monochrome area.

15. The image-processing apparatus according to claim 2, wherein
in a case where a ratio of the total number of color pixels of the first image in a monochrome area shown by the result of the second determination process on the first image, to the total pixel number of the monochrome area is an eighth threshold value or greater, the area-determination unit determines the monochrome area as a color area.

16. The image-processing apparatus according to claim 2, wherein
in a case where the second determination process on the second image is performed, the differential-determination unit determines a differential value indicating a difference between the result of the first determination process on the first image and a result of the second determination process on the second image, in place of the differential value indicating the difference between the result of the first determination process on the first image and the result of the first determination process on the second image.

17. An image-processing method comprising:
inputting an image; and
determining a monochrome area and a color area by performing a first determination process on the input image, wherein
a monochrome area and a color area are determined by performing a second determination process whose processing accuracy is higher than that of the first determination process on the input image, in a case where magnitude of temporal change of a result of the first determination process is a first threshold value or greater.

18. A non-transitory computer readable medium that stores a program, wherein the program causes a computer to execute the method according to claim 17.
